(19) United States
(12) Patent Application Publication
(10) Pub. No.: US 2006/0230856 A1
(43) Pub. Date: Oct. 19, 2006

(54) Linear motion device

(75) Inventors: Shigeru Okita, Kanagawa (JP); Hideyuki Uyama, Kanagawa (JP); Susumu Tanaka, Kanagawa (JP); Kenichi Iso, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/433,423

(22) Filed: May 15, 2006

Related U.S. Application Data
(62) Division of application No. 10/411,329, filed on Apr. 11, 2003.

(30) Foreign Application Priority Data
Apr. 11, 2002 (JP) P.2002-109409
Apr. 19, 2002 (JP) P.2002-117853
May 14, 2002 (JP) P.2002-138957
May 29, 2002 (JP) P.2002-155977
Jun. 17, 2002 (JP) P.2002-175835

(51) Int. Cl. F16H 1/24

(52) U.S. Cl. 74/424.88; 384/51

(57) ABSTRACT

A ball screw (1) as a linear motion device according to the invention has retaining pieces (21) each having two concave surfaces (23) facing adjacent ones of rolling elements (9) respectively. Each of the retaining pieces (21) is disposed between adjacent ones of the rolling elements (9). A carbonitrided layer containing residual austenite of 15-40% by volume is provided in the surface layer of each of the rolling elements (9).

### BACKGROUND OF THE INVENTION

1. Field of the Invention

The present invention relates to a linear motion device, specifically a ball screw, and particularly relates to elongation of the life of a linear motion device for use in a swinging portion in an electrically-operated injection molding machine, an electrically-operated pressing machine, or the like, to which a high load is applied intermittently and which is used very often for reciprocating motion in a short stroke.

2. Description of the Related Art

A ball screw has been recently popularly used as a substitute for a hydraulic cylinder so that rotational motion can be converted into linear motion in an electrically-operated injection molding machine, an electrically-operated pressing machine or the like, and that linear motion can be performed smoothly without frictional loss.

For example, the ball screw of full-ball type being one example of the linear motion device includes a screw shaft having a helical male thread groove formed in its outer circumferential surface, a nut having a helical female thread groove formed in its inner circumferential surface so that the pitch of the female thread groove is the same as that of the male thread groove, and balls interposed between the male thread groove and the female thread groove so as to roll freely. A circulation path for making one end side of the female thread groove communicate with the other end side of the female thread groove is formed in the nut.

When the screw shaft and the nut are rotated relative to each other, the balls move forward in the female thread groove while rolling in a rolling path formed between the male thread groove and the female thread groove. Each ball reaching one end side of the female thread groove circulates from one end side of the female thread groove to the other end side of the female thread groove through the circulation path, so that the ball is supplied into the rolling path between the male thread groove and the female thread groove and rolls in the rolling path again.

The balls rolling in between the male thread groove and the female thread groove rotate in one direction. When adjacent ones of the balls come into direct contact with each other, relative slip having a speed twice as high as the rolling speed is generated because the balls move in directions reserve to each other in ball surfaces which are contact portions. There is a possibility of generating a phenomenon called “competition between balls”. As a result, there is a disadvantage in that the ball surfaces may be abraded early or in that burning of the balls and the thread grooves may be caused by frictional heat.

Each of contact points between each ball and the screw shaft or between each ball and the nut is shaped like a very small ellipse called “contact ellipse” through grease or a lubricant, so that surface pressure at the contact point becomes extremely high.

The related-art ball screw is produced from special materials so that the ball screw can bear the high surface pressure. That is, carburized bearing steel such as SCM420 or induction hardened steel such as SAE4150, which is heated so that the surface hardness of the material is adjusted to about HRC 56-63, is used as the material of each of the screw shaft and the nut.

High-carbon chromium bearing steel such SUJ2, which is quench-hardened to have a surface hardness of not lower than HRC 60, is used as the material of each of the balls.

The ball screw used in an electrically-operated injection molding machine, an electrically-operated pressing machine or the like is used in a short stroke in which a high load is applied instantaneously. The ball screw is used under a severe condition of reciprocating motion in which backward rotation is made after once interruption is performed in a state in which the maximum load acts on the ball screw.

For this reason, an oil film on the ball-rolling surface is scraped off, so that a lubricant may hardly enter the contact surface between the thread grooves and each ball. There is a tendency for the oil film to be formed insufficiently. There is a problem that abrasion and peeling due to surface damage occurs easily in the rolling surfaces of the screw shaft, the nut and the balls.

The damage due to the competition between balls is remarkable particularly in the contact surface between adjacent ones of the balls in which relative slip having a speed twice as high as the rolling speed of each ball is generated.

Furthermore, deformation of a machine table due to the action of a high load or misalignment at the time of mounting makes the competition between balls more remarkable to thereby shorten the life of the ball screw more greatly.

In order to prevent balls from wearing and improve the durability, a ball screw in which carbonitriding treatment is applied to the surfaces of balls so as to improve the lives of the balls has been proposed, for example, in JP-A-10-103445 and JP-A-11-300803. According to the ball screw, carbonitriding treatment is applied to the surfaces of balls so as to deposit plenty of martensitic structure on the surfaces. Thus, the surface hardness of the balls is enhanced so that the sensibility to cracks is reduced.

However, when there occurs competition between the balls, damage to the ball surfaces cannot be avoided even if the hardness of the ball surfaces is enhanced by the carbonitriding treatment applied to the ball surfaces. The damage causes breakage of a screw shaft or a nut in an early stage due to failure in lubrication.

As means for eliminating the competition between balls, a ball screw of the type in which spacer balls each having a diameter smaller by approximately a value of from the order of microns to the order of tens of microns than that of each load ball are interposed between the load balls bearing a load has been proposed in JP-A-2000-291770.

Although the competition between balls can be eliminated by the interposition of the spacer balls, the spacer balls cannot receive the load so that the number of balls receiving the load is substantially reduced. There is a problem that the load allowed to be imposed on the ball screw is reduced.

As a ball screw in which the competition between balls is prevented as well as great reduction in allowable load is avoided, a ball screw having retaining pieces each interposed between adjacent ones of balls and having a pair of concave surfaces facing the adjacent ones of the balls respectively has been disclosed, for example, in JP-A-11-315835, JP-A-2000-199556, JP-A-2001-21018, JP-A-2001-124172 and JP-A-13-124172.

Because the balls are disposed so as to be in contact with the concave surfaces of the retaining pieces respectively, a considerably large number of load balls can be disposed compared with the ball screw using the spacer balls. Reduction in allowable load can be suppressed.

Furthermore, because the competition between balls is eliminated, a lubricant can be held in each of the concave surfaces of the retaining pieces. There is an advantage in that lubricating failure is reduced remarkably.

A ball screw formed so that the curvature radius of each thread groove shaped like a so-called Gothic arch is reduced in order to reduce surface pressure at a contact ellipse which is one of contact points between each ball and the screw shaft or between each ball and the nut has been also proposed.

For example, JP-A-2000-39052 has disclosed a ball screw in which the curvature radius of the male thread groove of the screw shaft is selected to be smaller than the curvature radius of the female thread groove of the nut to thereby reduce the contact surface pressure between the male thread groove and each ball to relax the condition of the screw shaft being damaged more easily than the nut to attain elongation of the life of the ball screw.

When the ball screw is used under a high-load condition, large shearing force, however, acts on the inside of the material just under the contact ellipse. There is a problem that the screw shaft or the nut results in being peeled although the retaining pieces are used for eliminating the competition between balls while the curvature radius of the male thread groove of the screw shaft is reduced to reduce the contact surface pressure between the male thread groove and each ball.

Accordingly, the ball screw can hardly bear the severe use condition of reciprocating motion at a high speed, under a high load and in a short stroke even in the case where the retaining pieces are interposed between the balls to prevent the competition between the balls while the curvature radius of the male thread groove is reduced to reduce the contact surface pressure. There is still room for improvement in order to achieve the long life of the ball screw.

Further, the present inventors have examined a damage mode of the ball screw having retaining pieces interposed between balls. As a result, it has been found that peeling changes from surface start type peeling caused by lubricating failure with a surface as the starting point to combined peeling in which the surface start type peeling is combined with inside start type peeling with an inside as the starting point. The inside start type peeling cannot be avoided perfectly even if the lubricating performance of a lubricant is improved. The life of the ball screw having retaining pieces cannot be elongated to its maximum unless the inside start type peeling is prevented.

On the other hand, lithium soap-mineral oil-based grease or lithium composite soap-mineral oil grease-based is generally enclosed in the ball screw. The strength of a thickener is however so insufficient that both heat resistance and oil film retention property are low. Particularly for the purpose of use in a high load-applied apparatus such as an electrically-operated injection molding machine or a pressing machine, a satisfied result has been never obtained in terms of the life of the ball screw.

### SUMMARY OF THE INVENTION

An object of the invention is to provide a long-lived linear motion device (ball screw) in consideration of such circumstances and particularly provide a linear motion device (ball screw) which can be kept long-lived even in the case where a high load is imposed on the ball screw.

A linear motion device according to a first aspect of the invention includes: a linear motion body fitted to a shaft and guided by the shaft so as to be able to move linearly axially; a plurality of rolling elements disposed between the shaft and a rolling element groove formed in an inner circumferential surface of the linear motion body so as to roll freely; and a circulation path formed in the linear motion body and for circulating the rolling elements from one end side of the rolling element groove to the other end side thereof; wherein each of retaining pieces having two concave surfaces facing adjacent ones of the rolling elements respectively is disposed between the adjacent ones of the rolling elements, while a carbonitrided layer containing residual austenite of 15-40% by volume is provided in a surface layer of each of the rolling elements.

According to the linear motion device configured thus, each of the retaining pieces having two concave surfaces facing adjacent ones of the rolling elements respectively is disposed between the adjacent ones of the rolling elements. As a result, the rolling elements roll and circulate together with the retaining pieces in the rolling element groove while being in contact with, for example, the Gothic-arch-like concave surfaces of the retaining pieces with extremely low friction. Thus, the competition between the rolling elements is prevented so that operation failure and production of noise and abnormal sound, and frictional damage of the rolling elements can be prevented from being caused by competition between the rolling elements.

In addition, a considerably large number of load rolling elements than in a linear motion device using spacer balls can be disposed so that the lives of the rolling elements can be elongated without reducing the allowable load capacity.

Further, a carbonitrided layer containing residual austenite of 15-40% by volume is provided in the surface layer of each of the rolling elements. Accordingly, high surface hardness and moderate softness can be provided to the rolling elements. Thus, when the rolling elements roll in the rolling element groove and the circulation path, the shock when the rolling elements abut against the rolling element groove and the circulation path is relieved so that the rolling element groove and the circulation path, particularly the connection portion from the rolling element groove to the circulation path suffering a large shock load, or the corner portion formed in the connection portion from the circulation path to the rolling element groove can be prevented from falling away as a large peeling piece. Thus, good lubricating conditions can be kept for a long time.

In addition, a shock load occurring when the linear motion device is stopped and reversed after the linear motion device suffers a maximum load can be relieved. As a result, the internal fatigue of the shaft and the linear motion body is relieved so that occurrence of inside start type peeling as will be described later can be prevented. Thus, the life of the linear motion device can be made long.

According to a second aspect of the invention, there is provided a linear motion device including a linear motion body fitted onto a shaft and guided by the shaft so as to be linearly movable in an axial direction, rolling elements disposed between the shaft and a rolling element groove formed in an inner circumferential surface of the linear motion body so as to roll freely, and a circulation path formed in the linear motion body and for circulating the rolling elements from one end side of the rolling element groove to the other end side of the rolling element groove, wherein: the linear motion device further includes retaining pieces each disposed between adjacent ones of the rolling elements and having a pair of concave surfaces facing the adjacent ones of the rolling elements respectively; and at least one kind of the shaft, the linear motion body and the rolling elements is made of steel containing 0.4% by weight to 0.9% by weight, both inclusively, of carbon (C), 2.5% by weight to 8.5% by weight, both inclusively, of chromium (Cr), 0.1% by weight to 2.0% by weight, both inclusively, of silicon (Si), 0.1% by weight to 2.0% by weight, both inclusively, of manganese (Mn), and the residual part of iron (Fe) or inevitable impurities while satisfying the relation: C content (% by weight)≦−0.05×Cr content (% by weight)+1.41 (% by weight).

According to the linear motion device configured as described above, because the retaining pieces each having a pair of concave surfaces facing adjacent ones of the rolling elements respectively are disposed between adjacent ones of the rolling elements, the rolling elements roll and circulate together with the retaining pieces in the rolling element groove, for example, while being in very-low frictional contact with the Gothic arch-shaped concave surfaces of the retaining pieces. As a result, the competition between the rolling elements can be prevented, so that operation failure, production of noise or abnormal sound and frictional damage of the rolling elements can be prevented from being caused by the competition between the rolling elements.

Furthermore, a considerably large number of load rolling elements can be disposed compared with the linear motion device using spacer balls, so that elongation in life can be attained without reduction in allowable load capacity.

Furthermore, because at least one kind of the shaft, the linear motion body and the rolling elements is made of steel containing 0.4% by weight to 0.9% by weight, both inclusively, of C, 2.5% by weight to 8.5% by weight, both inclusively, of Cr, 0.1% by weight to 2.0% by weight, both inclusively, of Si, 0.1% by weight to 2.0% by weight, both inclusively, of Mn, and the residual part of Fe or inevitable impurities while satisfying the relation: C content (˜6 by weight)≦−0.05×Cr content (% by weight)+1.41 (% by weight), the metal structure can be stabilized so that the generation of an abnormal structure can be restrained from being caused by rolling fatigue of the inside of the material just under the contact ellipse on which a large amount of shearing force acts. Accordingly, inside start type peeling can be prevented.

Preferably, in the linear motion device according to the second aspect of the invention, the at least one kind of the shaft, the linear motion body and the rolling elements may contains at least one component selected from the group consisting of 0.1% by weight to 1.5% by weight, both inclusively, of molybdenum (Mo), and 0.1% by weight to 1.5% by weight, both inclusively, of vanadium (V).

According to the linear motion device configured as described above, because the steel having the components further contains at least one component selected from the group consisting of 0.1% by weight to 1.5% by weight, both inclusively, of Mo, and 0.1% by weight to 1.5% by weight, both inclusively, of V, increase of the size of coarse crystal particles at the time of heat treatment is prevented as well as fine carbide is formed.

Moreover, the metal structure can be stabilized so that the generation of an abnormal structure can be suppressed greatly. Accordingly, inside start type peeling can be prevented from being caused by rolling fatigue of the portion on which a high load acts, so that the life of the ball screw can be elongated.

According to a third aspect of the invention, there is provided a ball screw including a screw shaft having a helical male thread groove formed in its outer circumferential surface, a nut having a helical female thread groove formed in its inner circumferential surface, and balls interposed in a rolling path formed between the male thread groove and the female thread groove so as to roll freely, wherein: the ball screw further includes retaining pieces each disposed between adjacent ones of the balls and having a pair of concave surfaces facing the adjacent ones of the balls; and a section taken along an axial line, of at least one of the male thread groove and the female thread groove has a curvature radius not smaller than 52.5% and not larger than 55% as large as the diameter of each of the balls.

According to the ball screw configured as described above, because each retaining piece having a pair of concave surfaces facing adjacent ones of the balls respectively is disposed between the adjacent ones of the balls, for example, the balls roll and circulate together with the retaining pieces in the rolling path while the balls come into very low-frictional contact with the Gothic arch-shaped concave surfaces of the retaining pieces. As a result, the competition between the balls is prevented.

Accordingly, operation failure, production of noise and abnormal sound and frictional damage of the balls can be prevented from being caused by the competition between the balls.

Furthermore, a considerably large number of load balls can be disposed compared with the ball screw using spacer balls, so that elongation of the life of the ball screw can be attained without reduction in allowable load capacity.

Furthermore, because the curvature radius of the section taken along an axial line, of at least one of the male thread groove and the female thread groove is selected to be not smaller than 52.5% and not larger than 55% as large as the diameter of each ball, the generation of an abnormal structure can be restrained from being caused by rolling fatigue, so that peeling due to the abnormal structure can be prevented.

Preferably, in the ball screw according to the third aspect of the invention, the section of each of the male thread groove and the female thread groove may be shaped like a Gothic arch.

According to the ball screw configured as described above, because each of the thread grooves is shaped like a Gothic arch in sectional view, the gap between the edge of the thread groove and each ball can be prevented from being excessive even in the case where the curvature radius of the thread groove is made larger than ordinary in order to reduce the area of the contact ellipse to reduce slip at the contact point. Accordingly, accuracy in positioning of the screw shaft and the nut can be kept good.

Further, the inventors have made eager examination about the inside start type peeling. As a result, it has been found that an abnormal structure causing such inside start type peeling is allied to a structure called “white structure” which is formed by dispersion of carbon atoms contained in cementite in a metal structure and which is generally regarded as being caused by static electricity in a contact region between metals. Therefore, the knowledge that mixing of an electrically conductive substance with an enclosed grease composition is effective in always eliminating the generated static electricity has been obtained. The invention has been accomplished.

That is, according to a fourth aspect of the invention, there is provided a ball screw including a screw shaft having a helical male thread groove formed in its outer circumferential surface, a nut having a helical female thread groove formed in its inner circumferential surface so that the female thread groove is opposed to the male thread groove, balls interposed between the male thread groove and the female thread groove so as to roll freely, and retaining pieces each disposed between adjacent ones of the balls and having a pair of concave surfaces facing the adjacent ones of the balls, wherein a grease composition containing 0.1% by mass to 10% by mass of an electrically conductive substance is enclosed.

In the ball screw, the behavior of each ball becomes complex because the state of the ball is changed from a loaded state to an unloaded state by a returning mechanism. On the other hand, the ball-rolling surface of each of the nut and the screw shaft is shaped like a Gothic arch. Accordingly, contact points between each ball and the screw shaft/nut change according to the loaded state so that the ball comes into contact with the screw shaft/nut at two, three or four points. Furthermore, because this fact is combined with the fact that the ball-rolling surface is helically continuous, an ideal rolling state is not obtained so that spin-slip occurs in the ball. Furthermore, each of the contact points between the ball and the screw shaft or between the ball and the nut is shaped like a narrow ellipse called “contact ellipse” through an oil film constituted by grease or lubricating oil, so that a very high surface pressure is generated even ordinarily. For this reason, in the ball screw incorporated in an electrically-operated injection molding machine, a pressing machine or the like and burdened with a high load, differential slip in the contact ellipse becomes very large.

Increase in such spin-slip and differential slip causes a tendency for strong friction to be produced between the ball and the screw shaft or between the ball and the nut and for static electricity to be generated in the contact region therebetween. As a result, there comes the situation that white structure (abnormal structure) is generated easily by static electricity. In the invention, therefore, an electrically conductive substance is mixed with the enclosed grease composition to always eliminate the static electricity to thereby suppress the generation of an abnormal structure to prevent the inside start type peeling.

Moreover, as to the inside start type peeling, the inventors obtained the knowledge that enclosure of a sulfonate-free grease composition is effective has been obtained.

That is, according to a fifth aspect of the invention, there is provided a ball screw including a screw shaft having a helical male thread groove formed in its outer circumferential surface, a nut fit on the screw shaft and having a helical female thread groove formed in its inner circumferential surface to oppose the female thread groove to the male thread groove, balls interposed between the male thread groove and the female thread groove so as to roll freely, and retaining pieces each disposed between adjacent ones of the balls and having a pair of concave surfaces facing the adjacent ones of the balls, wherein a sulfonate-free grease composition is enclosed.

It is particularly preferable that the grease composition contains a urea compound as a thickener, and 0.1% by mass to 10% by mass of at least one kind of antirust additive selected from the group consisting of naphthenates, and succinic derivatives, or that the grease composition contains a urea compound as a thickener, and 0.1% by mass to 10% by mass of organometallic salt. In this configuration, the ball screw is longer-lived more greatly.

In the ball screw, the behavior of each ball becomes complex because the state of the ball is changed from a loaded state to an unloaded state by a returning mechanism. On the other hand, the ball-rolling surface of each of the nut and the screw shaft is shaped like a Gothic arch. Accordingly, contact points between each ball and the screw shaft/nut change according to the loaded state so that the ball comes into contact with the screw shaft/nut at two, three or four points. Furthermore, because this fact is combined with the fact that the ball-rolling surface is helically continuous, an ideal rolling state cannot be obtained so that spin-slip occurs in the ball. Furthermore, each of the contact points between the ball and the screw shaft or between the ball and the nut is shaped like a narrow ellipse called “contact ellipse” through an oil film constituted by grease or lubricating oil, so that a very high surface pressure is generated even ordinarily. For this reason, in the ball screw incorporated in an electrically-operated injection molding machine, a pressing machine or the like and burdened with a high load, differential slip in the contact ellipse becomes very large.

Increase in such spin-slip and differential slip causes a tendency for a mechanochemical reaction to be produced between the ball and the screw shaft or between the ball and the nut because both the ball and the screw shaft/nut are made of metal. As a result, there comes the situation that white structure (abnormal structure) is generated easily.

On the other hand, a grease composition containing antirust additives is often enclosed in the ball screw used in an electrically-operated injection molding machine, a pressing machine or the like. The inventors have examined the correlation between the kind of the antirust additives and the generation of the white structure. As a result, it has been found that metal sulfonate used popularly because of its excellent antirust characteristic has a tendency toward the promotion of the mechanochemical reaction compared with other antirust additives. It is conceivable that this is caused by the sulfonate's property of being easily deposited on metal surfaces. On the other hand, when a urea compound is used as a thickener, a firmer oil film can be formed to suppress occurrence of metallic contact. The invention is based on the aforementioned knowledge.

### BRIEF DESCRIPTION OF THE DRAWINGS

FIG. 1 is a plan view of a ball screw showing a linear motion device according to the invention;

FIG. 2 is a longitudinal sectional view taken along liner A-A in FIG. 1;

FIG. 3 is longitudinal sectional view along a thread groove in FIG. 2;

FIG. 4 is an enlarged sectional view of a retaining piece in FIG. 3;

FIG. 5 is a graph of test results, showing the relationship among the presence/absence of retaining pieces, the residual austenite amount and the ball screw life according to a first embodiment of the invention;

FIG. 6 is a perspective view of a linear guide to which the invention has been applied;

FIG. 7 is a perspective view of a linear ball bearing to which the invention has been applied;

FIG. 8 is a graph of test results showing the relation between the amount of Cr contained in the steel material of the ball screw and the life of the ball screw according to a second embodiment;

FIG. 9 is an enlarged sectional view taken along the axial direction of the ball screw according to a third embodiment;

FIG. 10 is a graph showing the correlation between the ratio of the curvature radius of the male thread groove of the screw shaft to the diameter of each ball and the life ratio according to the third embodiment;

FIG. 11 is a graph showing results of a durability life test in Example 25 according to a fourth embodiment;

FIG. 12 is a graph showing the relation between the amount of added naphthenate or succinic derivative and the peeling life obtained in Examples 26 and 27 according to a fifth embodiment; and

FIG. 13 is a graph showing the relation between the amount of added organometallic salt and the peeling life obtained in Example 28 according to the fifth embodiment.

### DETAILED DESCRIPTION OF THE PREFERRED EMBODIMENTS

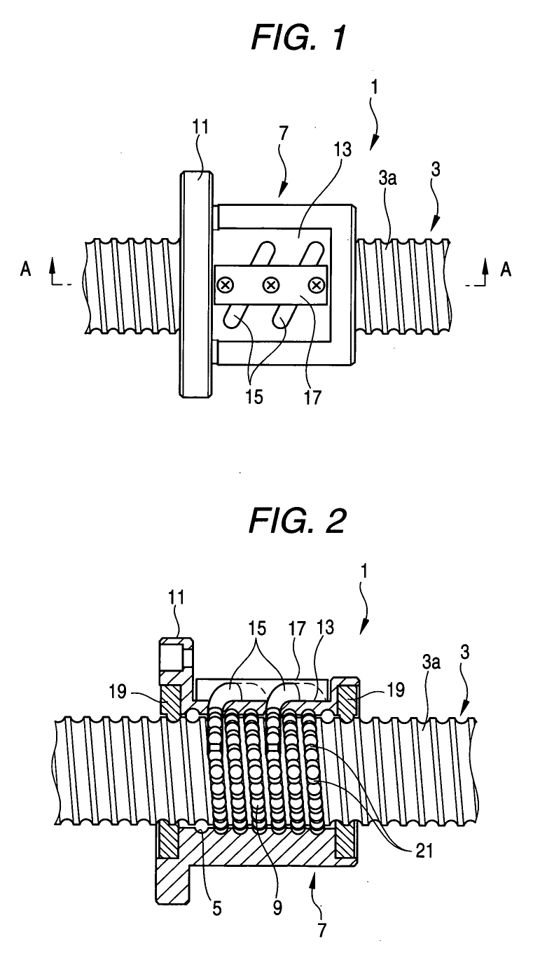

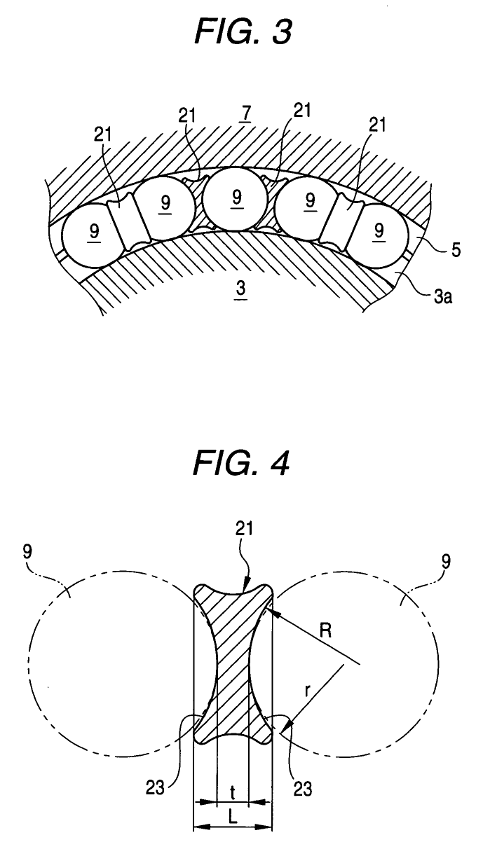

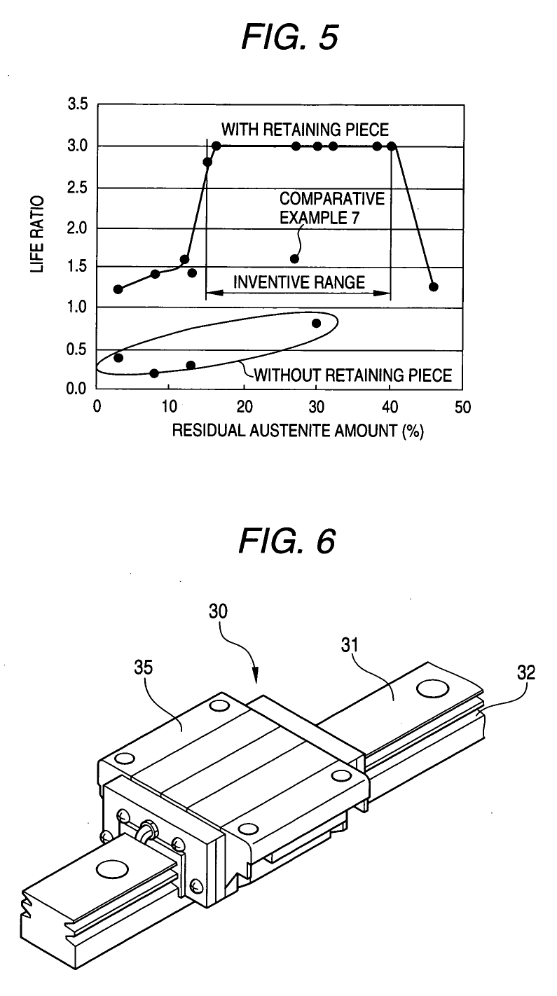

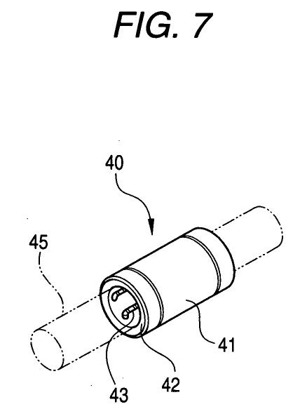

An embodiment of a linear motion device according to the invention will be described below with reference to FIGS. 1 to 7. FIG. 1 is a plan view of a ball screw which is an embodiment of a linear motion device according to the invention. FIG. 2 is a longitudinal sectional view taken along line A-A in FIG. 1. FIG. 3 is a longitudinal sectional view along a thread groove in FIG. 2. FIG. 4 is an enlarged sectional view of one of the retaining pieces depicted in FIG. 3. FIG. 5 is a graph showing the relationship among the presence/absence of retaining pieces, the residual austenite amount and the life ratio. FIG. 6 is a perspective view of a linear guide to which the linear motion device according to the invention has been applied. FIG. 7 is a perspective view of a linear ball bearing to which the linear motion device according to the invention has been applied.

As shown in FIGS. 1 to 4, a ball screw 1 which is an example of a linear motion device according to this embodiment includes a screw shaft 3 having a male thread groove 3a formed in its outer circumferential portion, a cylindrical nut 7 which is a linear motion body having a female thread groove 5 formed in its inner circumferential surface, and a plurality of balls 9 interposed between the male thread groove 3a and the female thread groove 5.

The screw shaft 3 is provided for guiding the nut 7 in the axial direction of the screw shaft 3. For example, the screw shaft 3 is produced by induction-hardening AISI5146 or the like, or carburizing or carbonitriding case-hardened steel of SCM420 or the like so as to adjust the surface hardness to about HRC 56-63.

In addition, the male thread groove 3a is formed to have a sectionally semicircular shape having a curvature radius substantially equal to a radius r of each ball 9 all over the outer circumferential surface, or a so-called Gothic arch shape in which circular arcs having a curvature radius slightly larger than the radius r of each ball 9 are crossed with each other in the intermediate portion.

The pitch of the male thread groove 3a can be arbitrarily selected in accordance with the specifications of an apparatus (not shown) in which the ball screw 1 will be incorporated.

The nut 7 is provided to move linearly in the axial direction of the screw shaft 3 and is cylindrically shaped. A flange 11 for fixing the nut 7 to a table (not shown) of the apparatus is formed at one end of the nut 7. A part of the outer circumferential surface of the nut 7 is cut away so that a flat portion 13 is formed in the cut portion.

For example, the nut 7 is produced by carburizing and quench-hardening case-hardened steel of SCM420 or the like, or quench-hardening/tempering high-carbon chromium bearing steel such as SUJ2 or SUJ3 so as to adjust the surface hardness to about HRC 56-63.

In addition, when corrosion resistance is required, martensitic stainless steel can be also used.

The female thread groove 5 having the same shape and the same pitch as the male thread groove 3a is formed in the inner circumferential surface of the nut 7. A steel tube 15 is fixed to the flat portion 13 by a tube pressing member 17 so as to form a circulation path making one end side of the female thread groove 5 communicate with the other end side of the female thread groove 5.

Then, the balls 9 are transported into the tube 15 so as to circulate from the one end side of the female thread groove 5 to the other end side of the female thread groove 5.

In addition, a plastic dust seal 19 is disposed at each of opposite ends of the nut 7 so as to prevent an alien substance from entering the nut 7 from the outside.

The balls 9 roll to allow the nut 7 to move linearly smoothly without friction loss. The balls 9 are disposed to roll freely in a rolling path formed between the male thread groove 3a and the female thread groove 5.

As the material of the balls 9 for use in the ball screw 1 according to this embodiment, high-carbon chromium bearing steel such as SUJ2 having the Si content of 0.35% or lower and the total Cr+2.5Mo content of 2.0% or lower, preferably 1.8% or lower, is used. The balls 9 are produced by applying carbonitriding treatment to the surface of the high-carbon chromium bearing steel, and then performing tumbling or ball-peening thereon, so as to adjust the residual austenite amount to 15-40% by volume in the surface layer and the surface hardness to HRC 62-67 (Hv 746-900).

As shown in FIGS. 3 and 4, each of retaining pieces 21 is interposed between adjacent ones of the balls 9 so that the balls 9 can be prevented from coming into direct contact with each other. For example, each of the retaining pieces 21 is made of polyamide, fluororesin, or nylon resin having a lubricating function in itself, or made of polyethylene impregnated with lubricating oil. Each of the retaining pieces 21 is shaped like a disk which is formed so that a pair of concave spherical surfaces 23 each having a curvature radius R larger than the radius r of each ball 9 are formed at opposite ends of the disk.

Accordingly, the thickness t of a central portion of each retaining piece 21 can be made small compared with the total length L so that the contact area between the ball 9 and the retaining piece 21 can be reduced to minimize frictional resistance as well as a large number of balls 9 can be disposed.

The shape of each of the concave spherical surfaces 23 is not limited to the spherical shape. Each of the surfaces 23 may be a concave surface shaped like a so-called Gothic arch which is formed so that two circular arcs cross each other at an intermediate portion. Or, each of the surfaces 23 may be a concave surface shaped like a cone. A through-hole may be provided between the two concave surfaces 23 of each retaining piece 21. A lubricant may be held in the through-hole so that the contact resistance between the ball 9 and the retaining piece 21 can be reduced.

The diameter (ds) of the retaining piece 21 is selected to be smaller than the diameter D of the ball 9 inclusive of the diameter of the ball 9 which is elastically deformed when the maximum load acts on the ball 9. When the retaining pieces 21 pass through the rolling path formed between the male thread groove 3a and the female thread groove 5 and pass through the tube 15 forming the circulation path, the retaining pieces 21 can circulate smoothly without interference with the rolling path, the tube 15 and a connection portion therebetween.

Specifically, the diameter (ds) of the retaining piece 21 is preferably selected to be 0.5 times to 0.9 times as large as the diameter D of the ball 9 (i.e., ds=0.5D to 0.9D).

If the gap between the ball 9 and the retaining piece 21 disposed in the rolling path is too large, the retaining piece 21 lies down so that it cannot fulfill its function. If the gap is too small, frictional force between the retaining piece 21 and the ball 9 increases to cause a factor of operation failure. Accordingly, the gap is selected to be optimized.

Specifically, the number of the balls 9/retaining pieces 21 is selected so that total gap S1, which is the gap formed between a ball 9 at the head and a retaining piece 21 at the tail on the assumption that all the balls 9 and retaining pieces 21 disposed in the rolling path are collected to one side, is larger than zero (S1>0) whereas gas S2, which is the gas formed between a ball 9 at the head and a ball 9 at the tail on the assumption that one retraining piece 21 at the tail is removed, is smaller than 0.8 times as large as the diameter (ds) of each retaining piece 21 (S2<0.8×ds). As a result, each retaining piece 21 is prevented from being inclined at an angle of about 60° or higher in the rolling path, so that it can fulfill its function well.

The operation of the ball screw according to this embodiment will be described.

As shown in FIGS. 1 to 3, in the ball screw 1 according to this embodiment, when the screw shaft 3 is rotated by a motor (not shown), the nut 7 moves in the axial direction of the screw shaft 3 while thread-engaged with the screw shaft 3 through the balls 9.

On this occasion, because the male thread groove 3a and the female thread groove 5 rotate in directions reverse to each other, the balls 9 roll with respect to the male thread groove 3a and the female thread groove 5 and move forward in the female thread groove 5. Each ball 9 reaching one end side of the female thread groove 5 is supplied to the other end side of the female thread groove 5 again while rolling in the tube 15, whereby the balls 9 are circulated.

In the ball screw 1, the direction of motion changes at the connection portion between the rolling path formed between the male thread groove 3a and the female thread groove 5 and the tube 15 which is the circulation path as well as the rolling path is helically continuous. Therefore, the load acting on the balls 9 at the connection portion changes rapidly from a loaded state to an unloaded state or inversely from an unloaded state to a loaded state, so that the behavior of each ball 9 becomes complex.

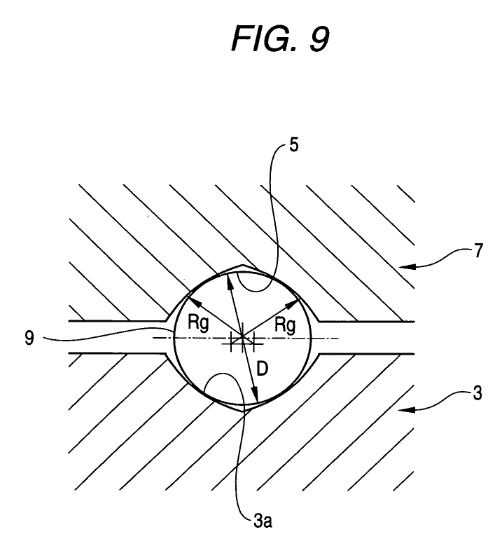

In case that each of the male thread groove 3a and the female thread groove 5 is shaped like a Gothic arch (see FIG. 9 described later), the contact state between each ball 9 and the male thread groove 3a and between each ball 9 and the female thread groove 5 varies according to the load. Each ball 9 rolls while the contact state varies to a two-point contact state, a three-point contact state or a four-point contact state.

Because the rolling path is helically continuous, each ball 9 does not roll in an ideal rolling state so that slip due to spinning motion occurs in between each ball 9 and the male thread groove 3a and between each ball 9 and the female thread groove 5.

Each of the contact points between each ball 9 and the male thread groove 3a and between each ball 9 and the female thread groove 5 is shaped like a small-area ellipse called “contact ellipse” through grease or lubricating oil, so that a very high surface pressure is generated in the contact ellipse portion. In the ball screw 1 on which a high load acts, differential slip at the contact ellipse is large because the contact ellipse is enlarged.

In the ball screw 1 used in an injection molding machine, a pressing machine or the like in a condition that a high load acts on the ball screw 1 intermittently, there is a tendency for abrasion of the balls 9 to be accelerated by the competition between the balls 9 peculiar to the ball screw.

Adjacent ones of the balls 9 are however prevented from coming into direct contact with each other because each retaining piece 21 is interposed between the adjacent ones of the balls 9. The slip velocity of the ball 9 relative to the retaining piece 21 is ½ as high as the velocity in the case where the adjacent balls 9 come into direct contact with each other.

Accordingly, the friction between the retaining piece 21 and the ball 9 becomes low, so that the retaining piece 21's own lubricity and the lubricity of grease held in the gap between the retaining piece 21 and the ball 9 can prevent the retaining piece 21 and the ball 9 from being abraded. Accordingly, the balls 9 can circulate in the rolling path smoothly without operation failure, production of noise, worsening of sound tone, etc. due to the competition between the balls 9, so that a smooth and quiet operation can be made for a long time.

As shown in FIG. 4, the thickness t between the concave spherical surfaces 23 formed in the central portion of each retaining piece 21 is so small that a large number of balls 9 can be disposed in the ball screw 1 compared with the ball screw using spacer balls. Accordingly, a ball screw 1 bearing a high load and having a larger stiffness can be produced.

The curvature radius R of each concave spherical surface 23 is selected to be larger than the radius r of each ball 9, so that drive resistance is reduced because grease can easily enter the gap between the ball 9 and the concave spherical surface 23 as well as slip resistance is reduced relatively because the contact area between the ball 9 and the retaining piece 21 can be reduced.

The outer diameter ds of each retaining piece 21 is selected to be in a range of from 0.5 times to 0.9 times as large as the diameter D of each ball 9, so that the retaining pieces 21 can circulate smoothly together with the balls 9 without interference with the rolling path, the tube 15 and the connection portion therebetween when passing through the rolling path and the tube 15. Change of torque and abrasion of the retaining pieces 21 can be also suppressed.

The gap between the balls 9 and the retaining pieces 21 in the rolling path and the tube 15 is set so that the total gap S1 satisfies the relation S1>0 while the gap S2 between the ball 9 at the head and the ball 9 at the tail satisfies the relation S2<0.8×ds on the assumption that one retaining piece 21 at the tail is removed. Accordingly, each retaining piece 21 is prevented from being inclined in the rolling path, so that a good operation can be kept.

The inventors have confirmed that a damage in the surface of the balls 9 is remarkably reduced, the life time of the ball screw 1 is largely extended by interposition of the retaining pieces 21 between the rolling balls 9 to eliminate the competition between the balls 9. However, even with the ball screw 1 in which the retaining pieces are interposed, there could be caused a damage in the use condition of high load. The inventors have made examination for many years about damage. As a result, it has been found that inside start type peeling is a damage mode other than surface start type peeling heretofore regarded as being caused by lubricating failure.

The inside start type peeling means that great shearing force acts on the inside of the material where a high load on the ball screw 1 is applied, so that the inside of the material is fatigued and finally peeled. This suggests that interposition of the retaining pieces 21 between the balls 9 is not a perfect countermeasure against the surface start type peeling caused by competition between the balls or the like, and there is room for improvement.

In the rolling path and the circulation path 15 of the ball screw 1, a portion having a sharp change in direction is inevitably provided for circulating the balls 9. That is, in the connection portion for connecting the rolling path with the tube 15 forming the circulation path, the direction is changed suddenly for picking up the balls 9 from the rolling path.

In addition, in the connection portion, the load acting on the balls 9 is removed suddenly (when the balls 9 roll from the rolling path to the circulation path), or on the contrary the balls 9 are suddenly brought into a high load state from a load-free state (when the balls 9 roll from the circulation path to the rolling path).

On this occasion, the balls 9 collide with the corner portion of the connection portion so as to be prevented from circulating smoothly, while an intermittent high load acts on the corner portion so that the corner portion adapts itself gradually while repeating peeling and falling away.

When peeling and falling away occur thus, a peeling piece is bitten into the rolling path suffering a high load, so that the lubricating conditions are further degraded. It is an effective countermeasure to perform large R-processing on the corner portion of the connection portion so as to reduce the magnitude of the load. However, this countermeasure is difficult to be a perfect countermeasure because of its problem in increasing the processing cost and in management.

Carbonitriding treatment is applied to the surfaces of the balls 9 so as to adjust the residual austenite amount to 15-40% by volume in the surface layer, and further tumbling or ball-peening is performed on the surfaces so as to adjust the surface hardness to HRC 62-67 (Hv 746-900). When the balls 9 produced thus are incorporated in the ball screw 1, damage can be reduced greatly.

That is, when the residual austenite amount is set to be 15-40% by volume, a softer structure than in the balls 9 having a martensitic structure in the related art is left so that the shock when the balls 9 collide with the corner portion of the connection portion can be relieved. Thus, the reduction of the life caused by biting of a large peeling piece can be prevented.

For the same reason, the shock load when the balls 9 are stopped and reversed after suffering a maximum load can be relieved so that the internal fatigue of the screw shaft 3 and the nut 7 can be reduced.

The reason why the residual austenite amount is set to be 15-40% by volume is that a sufficient buffer effect cannot be obtained if the residual austenite amount is lower than 15% by volume, and required surface hardness cannot be obtained if the residual austenite amount is higher than 40% by volume.

The reason why the surface hardness is set to be HRC 62-67 is that the life is shortened due to wearing of the balls 9 when the surface hardness is lower than HRC 62, and the residual austenite amount is inevitably reduced and hence the buffer effect is reduced when the surface hardness is higher than HRC 67. In order to obtain a desired result, it is preferable that the surface carbon concentration is set to be about 1.2-1.6% by weight, and the surface nitrogen concentration is set to be about 0.1-0.6% by weight.

In addition, high-carbon chromium bearing steel such as SUJ2 having the Si content of 0.35% or lower and the total Cr+2.5Mo content of 2.0% or lower, preferably 1.8% or lower, is used as the material of the balls 9. When the Si content increases, carbonitriding is blocked so that the depth of penetration of carbon and nitrogen cannot be secured. Consequently, the heat treatment time is made longer than necessary, or a thickness of a treated layer required for abrasive finishing after the heat treatment cannot be secured.

In addition, when the Si content increases, a conspicuous grain boundary oxidation layer is produced so that the cost of polishing is required to be higher than necessary, or there is a fear of short finishing.

The reason why the total Cr+2.5Mo content is set to be 2.0% or lower is that when the total Cr+2.5Mo content increases, coarse carbide may be produced in the carbonitriding treatment so that the lives of the balls 9 are reduced remarkably. It is preferable that the total Cr+2.5Mo content is set to be 1.8% or lower.

Incidentally, although the linear motion device according to the invention was described as a ball screw in the embodiment by way of example, the invention is not limited to the ball screw. As shown in FIG. 6, the invention is also applicable to a linear guide 30 having rolling element grooves 32 formed in both side surfaces of a guide rail 31, and a plurality of balls (not shown) disposed so as to roll freely in rolling element grooves and ball circulation paths provided inside a slider 35.

In addition, as shown in FIG. 7, the invention is also applicable to a device for allowing balls to roll to thereby move a linear motion body linearly, such as a linear ball bearing 40 including an outer pipe 41, a holder 42 received in the outer pipe 41 and having a substantially track-like guide groove formed to extend axially, and a plurality of balls 43 disposed to roll freely between the guide groove and a linear shaft 45 and to circulate through a circulation path.

### Examples of the First Embodiment

Description will be made about examples of linear motion devices according to the invention and comparative examples for comparison with those examples. That is, description will be made about testing on Examples 1 to 7 carried out for confirming the effect of the linear motion device according to the invention and on Comparative Examples 1 to 11 carried out for making comparison with Examples 1 to 7.

A ball screw known by the bearing number “25×10×500-C5” according to JIS-1192 was used for testing. The ball screw was mounted in a ball screw durability life tester made by NSK Ltd. in the following testing conditions, and a test time taken for occurrence of damage such as wearing or peeling was recorded.

The time required for the expiration of the lives of 10% of shorter-life ball screws of 10 samples was obtained by Weibull distribution, and this was regarded as a test life.

The test result is expressed by a ratio of the test time to a theoretical life time calculated in the testing conditions. Incidentally, when the test time reached to a time three times as long as the theoretical life time, the durable life was regarded as sufficient, and the test was closed.

A screw shaft used was produced by induction-hardening SAE5140, and a nut used was produced by carburizing carburized bearing steel of SCM420.

In addition, balls were produced as follows. That is, steel materials shown in Table 1 were headed and rough-polished to produce crude balls. The crude balls were carbonitrided under the condition of RX gas, enriched gas and ammonia gas (1.5-5%) at 820-840° C. for 1-3 hours, then oil-cooled and quench-hardened, tempered at 160-180° C. for 1.5-2 hours, and rough-polished. After that, the balls were tumble-finished to G20 equivalent.

TABLE 1

| | material | | | | | |
|---|---|---|---|---|---|---|
| | C | Si | Mn | Cr | Mo | Cr + 2.5Mo |
| A-1 | 1.02 | 0.25 | 0.30 | 1.49 | — | 1.49 |
| A-2 | 0.98 | 0.35 | 0.28 | 1.45 | — | 1.45 |
| A-3 | 1.02 | 0.29 | 0.28 | 1.06 | — | 1.60 |
| A-4 | 1.03 | 0.57 | 1.04 | 1.08 | — | 1.08 |
| A-5 | 1.02 | 0.28 | 0.31 | 1.51 | 0.21 | 2.04 |

Each of retaining pieces was made of synthetic resin, had conical concave surfaces facing adjacent ones of balls, and had an outer diameter 0.8 times as large as the diameter of the ball. In addition, the total gap S1 was set to be larger than 0 (S1>0), and the gap S2 between the ball at the head and the ball at the tail on the assumption that the retaining piece at the tail was removed was set to be smaller than 0.8 times as large as the outer diameter ds of the retaining piece (S2<0.8×ds).

<Testing Conditions>

Bearing Number: NSK ball screw 25×10×500-C5 (ball diameter 3/16 inches)
Testing Machine: ball screw durability life tester made by NSK Ltd.
Test Load: axial load 5800 N (P/C=0.5) moment load 15 N·m
Number of Revolutions: 100-200 r.p.m.
Stroke: 60 mm
Lubricant: Albania No. 2 (Showa Shell Sekiyu K.K.)

Table 2 shows the test results.

TABLE 2

| Example/ | | | | | surface | residual | | existence of | |
|---|---|---|---|---|---|---|---|---|---|
| Comparative | | | | | hardness | austenite | | retaining | life |
| Example | No. | material | carbonitriding | tumbling | (HRC) | (%) | other | piece | ratio |
| Examples | Example 1 | A-1 | Yes | yes | 62.0 | 40 | | yes | 3.0 |
| | Example 2 | A-1 | yes | yes | 63.2 | 32 | | yes | 3.0 |
| | Example 3 | A-1 | yes | yes | 67.0 | 15 | | yes | 2.8 |
| | Example 4 | A-2 | yes | yes | 62.3 | 38 | | yes | 3.0 |
| | Example 5 | A-2 | yes | yes | 63.4 | 30 | | yes | 3.0 |
| | Example 6 | A-3 | yes | yes | 63.7 | 27 | | yes | 3.0 |
| | Example 7 | A-3 | yes | yes | 65.2 | 16 | | yes | 3.0 |
| Comparative | Comp. Ex. 1 | A-1 | no | no | 62.2 | 8 | | yes | 1.4 |
| Examples | Comp. Ex. 2 | A-1 | no | yes | 63.7 | 3 | | yes | 1.2 |
| | Comp. Ex. 3 | A-1 | yes | no | 59.2 | 46 | | yes | 1.2 |
| | Comp. Ex. 4 | A-1 | yes | no | 61.8 | 13 | | yes | 1.4 |
| | Comp. Ex. 5 | A-1 | yes | yes | 67.2 | 12 | | yes | 1.6 |
| | Comp. Ex. 6 | A-4 | yes | no | — | — | occurrence of | — | — |
| | | | | | | | short finishing | | |
| | Comp. Ex. 7 | A-5 | yes | yes | 63.4 | 27 | | yes | 1.6 |
| | Comp. Ex. 8 | A-1 | no | no | 62.2 | 8 | | no | 0.2 |
| | Comp. Ex. 9 | A-1 | no | yes | 63.7 | 3 | | no | 0.4 |
| | Comp. Ex. | A-1 | yes | no | 61.8 | 13 | | no | 0.3 |
| | 10 | | | | | | | | |
| | Comp. Ex. | A-2 | yes | yes | 63.4 | 30 | | no | 0.8 |
| | 11 | | | | | | | | |

In each of Examples 1 to 7, retaining pieces were interposed between balls, and a carbonitrided layer containing residual austenite of 15-40% by volume was provided in each surface layer of the balls. Accordingly, there is no damage caused by the competition of the balls, and the shock on the rolling path and the corner portion of the connection portion was relieved, while the shock on the balls when the balls were reversed was also relieved. As a result, except that the life ratio was 2.8 in Example 3, the life ratio was 3.0 in each of Examples 1 to 7, so that long life could be attained, and effectiveness of the invention was proved.

Incidentally, the reason why the life ratio was 3.0 in all the examples but Example 3 was that the test was closed at that time. When the ball screws were taken apart after the test and the degree of the internal damage was examined, the degree of the damage was so low that the ball screws were still in usable condition.

On the other hand, in Comparative Examples 1 and 2, balls produced by quench-hardening and tempering bearing steel of SUJ2 so as to adjust the surface hardness to about HRC 62-63 were used, and retaining pieces were interposed between the balls. In comparison with any one of Examples of the invention, each of the shafts, the nuts and the balls was damaged remarkably, and the lives of the ball screws were short.

In Comparative Example 3, balls produced by carbonitriding bearing steel of SUJ2 were used, and retaining pieces were interposed between the balls. The lives of the balls were short because the residual austenite amount in the ball surface was large to be 46% and hence the surface hardness was low to be about HRC 59.

In Comparative Examples 4 and 5, balls produced by carbonitriding bearing steel of SUJ2 were used, and retaining pieces were interposed between the balls. The surface hardness was comparatively high, but the residual austenite amount in the ball surface was small to be about 12%. Thus, since the residual austenite amount was not secured sufficiently, the surfaces of the balls were damaged more violently than those in Examples of the invention, so that the lives of the balls were shorter.

In Comparative Example 6, the thickness of a carbonitrided layer was not sufficient to secure the machining allowance. As a result, there occurred short finishing regarded as a grain boundary oxidation layer. Thus, the subsequent evaluation was canceled.

In Comparative Example 7, the Cr and Mo content in the material components was so high that the Cr+2.5Mo content reached 2.04% (see Table 1). For this reason, somewhat coarse carbide was produced in carbonitriding treatment so that the lives of the balls were lowered.

Each of Comparative Examples 8 toll provided a related-art ball screw in which balls produced in various conditions shown in Table 2 were used and retaining pieces were not used. Since there was no function of the retaining pieces for preventing competition of the balls, the ball surface was damaged violently so that there occurred a failure in lubrication. As a result, peeling was confirmed in all the portions of the screw shaft, the nut and the balls. Thus, the life of the ball screw was extremely short.

The various test results of Examples and Comparative Examples are shown in FIG. 5 in the form of the relationship between the residual austenite amount and the life ratio. The retaining pieces and the residual austenite amount owing to the carbonitriding treatment had great influence on the life. Each ball screw having a residual austenite amount of 15-40% by volume and using retaining pieces had a very long life. The effectiveness of the invention was therefore proved.

As described above, in a linear motion device according to the first embodiment of the invention, retaining pieces each having two concave surfaces facing adjacent ones of rolling elements respectively are interposed between adjacent ones of the rolling elements respectively. Accordingly, the rolling elements roll and circulate in a rolling element groove while being in contact with, for example, the Gothic-arch-like concave surfaces of the retaining pieces with extremely low friction. Thus, the competition between the rolling elements is prevented so that operation failure and production of noise and abnormal sound, and the frictional damage of the rolling elements can be prevented from being caused by competition between the rolling elements.

In addition, a considerably large number of load rolling elements than in a linear motion device using spacer balls can be disposed so that the lives of the rolling elements can be elongated without reducing the allowable load capacity.

Further, a carbonitrided layer containing residual austenite of 15-40% by volume is provided in the surface layer of each of the rolling elements. Accordingly, high surface hardness and moderate softness can be provided to the rolling elements. Thus, when the rolling elements roll in the rolling element groove and the circulation path, the shock when the rolling elements abut against the rolling element groove and the circulation path is relieved so that the rolling element groove and the circulation path, particularly the connection portion from the rolling element groove to the circulation path, or the corner portion formed in the connection portion from the circulation path to the rolling element groove can be prevented from falling away as a large peeling piece. Thus, good lubricating conditions can be kept for a long time.

In addition, a shock load acting on the rolling elements when the linear motion device is stopped and reversed after the linear motion device suffers a maximum load can be relieved. As a result, the internal fatigue of the shaft and the linear motion body is relieved so that the life of the linear motion device can be made long.

Next, a description will be given of a second embodiment of the invention.

In the second embodiment, at least one of constituent members of the ball screw 1, that is, the screw shaft 3, the nut 7 or each of the balls 9, is made of steel containing the following components. That is, at least one constituent member is made of a steel material containing 0.4. % by weight to 0.9% by weight, both inclusively, of C, 2.5% by weight to 8.5% by weight, both inclusively, of Cr, 0.1% by weight to 2.0% by weight, both inclusively, of Si, 0.1% by weight to 2.0% by weight, both inclusively, of Mn, and the residual part of Fe or inevitable impurities while satisfying the relation: C content (% by weight)≦−0.05×Cr content (% by weight)+1.41 (% by weight). The steel material used is heated so that the surface hardness of the steel material is adjusted to an optimal hardness, e.g., to about HRC 56-63.

In addition to the components, the steel may further contains at least one component selected from 0.1% by weight to 1.5% by weight, both inclusively, of Mo, and 0.1% by weight to 1.5% by weight, both inclusively, of V.

The remaining components and operations of the linear motion device of the second embodiment are identical to those of the first embodiment.

In the second embodiment, the inventors have made examination for many years about fatigue damage produced in the use condition of high rotational speed and high load in spite of interposition of the retaining pieces 21 between the rolling balls 9 to eliminate the competition between the balls 9. As a result, it has been found that inside start type peeling is a damage mode other than surface start type peeling heretofore regarded as being caused by lubricating failure.

That is, there has been obtained the knowledge that a large amount of shearing force acts on the inside of the material just under the contact ellipse so that an abnormal structure produced with the advance of rolling fatigue of the inside of the material becomes a factor of peeling.

This suggests that a problem having been not solved yet still remains even in the case where the retaining pieces 21 are interposed between the balls 9.

The abnormal structure is a structure called “white structure” in which dispersion of carbon contained in cementite in the metal structure is caused by rolling fatigue. Although the mechanism of generation of such an abnormal structure is not clear for the time being, it is conceivable that the abnormal structure will be caused by a mechanochemical reaction or hydrogen penetrating into steel because the abnormal structure is apt to be generated under the condition of large slip and high load.

According to further detailed examination about the abnormal structure, there has reached a conclusion that the generation of the abnormal structure can be suppressed to elongate the life of the ball screw when components of the metal, especially the content of the Cr component, are optimized.

The function of alloy components used in the second embodiment and the reason why ranges of the components are limited will be described below.

Carbon (C): 0.4% by weight to 0.9% by weight

Carbon can be dissolved in the base while kept in a solid state, so that carbon has a function of improving hardness to increase strength after quench-hardening and tempering. Carbon can be combined with a carbide-forming element such as Cr to produce carbide, so that carbon also has a function of improving abrasion resistance.

If the C content is smaller than 0.4% by weight, the amount of carbon dissolved in the base while kept in a solid state is so short that sufficient hardness cannot be ensured after quench-hardening and tempering.

If the C content is larger than 0.9% by weight, coarse eutectic carbide is apt to be produced at the time of steel making so that the fatigue life and strength may be spoiled remarkably. In addition, cold processability and machinability may be lowered disadvantageously to the cost. Preferably, the C content may be selected to be in a range of from 0.5% by weight to 0.8% by weight.

Chromium (Cr): 2.5% by weight to 8.5% by weight

Chromium is an element playing the most important role. Chromium stabilizes the metal structure to restrain greatly the abnormal structure from being produced from martensite and cementite. Chromium also stabilizes an oxide film generated on a surface of steel to thereby suppress mechnochemical reaction and penetration of hydrogen.

Cr can be dissolved in the base while kept in a solid state, so that Cr has a function of improving softening resistance and corrosion resistance after quench-hardening and tempering. Cr can be used for forming fine carbide to prevent increase of the size of coarse crystal particles at the time of heat treatment, so that Cr also has a function of improving fatigue life characteristic and abrasion resistance.

If the Cr content is smaller than 2.5% by weight, the effect of suppressing the generation of the abnormal structure is small. If the Cr content is larger than 8.5 t by weight, cold processability and machinability may be lowered to bring increase in cost. In addition, coarse eutectic carbide may be produced so that the fatigue life and strength may be spoiled remarkably.

In consideration of the abnormal structure suppressing effect and the fatigue life, the Cr content may be preferably selected to be in a range of from 3.0% by weight to 7.5% by weight.

Manganese (Mg): 0.1% by weight to 2.0% by weight

Manganese is a necessary element as a deoxidation absorber at the time of steel making. 0.1% by weight or more of manganese can be added, so that manganese can be dissolved in the base while kept in a solid state, and manganese has a function of improving quench-hardenability.

If the Mg content is larger than 2.0% by weight, the martensitic transformation initiating temperature may be reduced so that sufficient hardness cannot be obtained as well as cold processability and machinability may be lowered. Preferably, the Mg content may be selected to be in a range of from 0.2% by weight to 1.5% by weight.

Silicon (Si): 0.1% by weight to 2.0% by weight

Like Mn, 0.1% by weight or more of silicon can be added as a deoxidation absorber at the time of steel making. Like Cr and Mn, silicon is effective in improving quench-hardenability and in improving temper-softening resistance to strengthen the base martensite to elongate the bearing life.

If the Si content is larger than 2.0% by weight, there is a possibility that machinability, forgeability and cold processability may be lowered. Preferably, the Si content may be selected to be in a range of from 0.5% by weight to 1.5% by weight.

C content (% by weight)≦−0.05×Cr content (% by weight)+1.41 (% by weight)

If the C content and the Cr content cannot satisfy the relation though the amounts of the components contained are in the aforementioned ranges respectively, coarse eutectic carbide may be produced at the time of steel making so that the fatigue life and strength may be spoiled remarkably by stress concentration onto the eutectic carbide.

Preferably, the size of the eutectic carbide may be selected to be not larger than 20 μm.

Molybdenum (Mo): 0.1% by weight to 1.5% by weight

Like Cr, molybdenum can be dissolved in the base while kept in a solid state, so that molybdenum has a function of improving quench-hardenability, temper-softening resistance and corrosion resistance. Molybdenum can be used for forming fine carbide to prevent increase of the size of coarse crystal particles at the time of heat treatment, so that molybdenum also has a function of improving fatigue life characteristic and abrasion resistance. In addition, molybdenum stabilizes the structure to restrain greatly the structure from changing to the abnormal structure.

For this reason, molybdenum can be selectively added by the amount acceptable in terms of cost. If an excessive amount of molybdenum is added, cold processability and machinability may be lowered to bring remarkable increase of the cost or coarse eutectic carbide may be produced to spoil the fatigue life and strength remarkably.

In consideration of abrasion resistance and cost, the Mo content may be preferably selected to be in a range of from 0.3% by weight to 1.0% by weight.

Vanadium (V): 0.1% by weight to 1.5% by weight

Vanadium is an element which is strongly effective in producing carbide and nitride. Vanadium has a function of improving strength and abrasion resistance remarkably. In addition, vanadium stabilizes the structure to restrain greatly the structure from changing to the abnormal structure.

For this reason, vanadium can be selectively added by the amount acceptable in terms of cost. If an excessive amount of vanadium is added, cold processability and machinability may be lowered to bring remarkable increase of the cost or coarse eutectic carbide may be produced to spoil the fatigue life and strength remarkably.

In consideration of abrasion resistance and cost, the V content may be preferably selected to be in a range of from 0.3% by weight to 1.0% by weight.

The linear motion device of the second embodiment is not also limited to the ball screw, but can be applied to a linear guide 30 as shown in FIG. 6 or a linear ball bearing 40 as shown in FIG. 7.

The material of each ball 9 is not limited to the alloy steel provided by the invention. For example, high-carbon chromium bearing steel such as SUJ2 or high-carbon chromium bearing steel subjected to a hardening process such as carbonitriding may be used as the material of each ball 9.

### Examples of the Second Embodiment

Examples of the linear motion device according to the second embodiment of the invention and Comparative Examples for making comparison with the Examples will be described. That is, a test executed on Examples 8 to 16 for confirming the effect of the linear motion device according to the second embodiment and executed on Comparative Examples 12 to 17 for making comparison with the Examples 8 to 16 will be described.

A ball screw known by the bearing number “25×10×500-C5” according to JIS-1192 was used in the test. The ball screw was mounted in a ball screw durability life tester made by NSK Ltd. in the following test condition. Whenever a predetermined time passed, the test was interrupted to check whether the screw shaft was peeled or not. The test time until peeling occurs was regarded as the lifetime.

Each of the screw shaft and the nut was made of a steel material containing alloy components shown in Table 3. After annealed, the steel material was roughly cut by a turning process. After quench-hardened and tempered, the steel material was finished by a grinding process.

Quench-hardening of the screw shaft was made by induction hardening. A vacuum furnace was used for quench-hardening the nut so that utter quench-hardening of the nut was started at the temperature of 840° C. to 1060° C. SCM420 used for comparison was carburized and quench-hardened. SAE4150 was processed by induction hardening. Each of the balls was produced out of high-carbon chromium bearing steel such as SUJ2.

Incidentally, each of materials A to G was a steel material containing alloy components provided by the invention.

TABLE 3

| | C | Cr | Si | Mn | Mo | V | |
|---|---|---|---|---|---|---|---|
| | % by | % by | % by | % by | % by | % by | |
| | weight | weight | weight | weight | weight | weight | C ≦ −0.05 × Cr + 1.41 |
| Material A | 0.9 | 2.5 | 1.4 | 1.1 | | | Yes |
| Material B | 0.7 | 3.0 | 0.9 | 0.3 | | | Yes |
| Material C | 0.9 | 5.1 | 0.5 | 1.0 | | | Yes |
| Material D | 0.5 | 7.5 | 1.0 | 0.4 | | | Yes |
| Material E | 0.7 | 8.5 | 0.4 | 0.3 | | | Yes |
| Material F | 0.7 | 3.1 | 1.1 | 0.3 | 1.1 | | Yes |
| Material G | 0.4 | 6.9 | 0.5 | 0.4 | | 0.6 | Yes |
| Material H | 0.7 | 2.1 | 1.1 | 0.4 | | | Yes |
| Material I | 1.1 | 7.1 | 0.4 | 0.3 | | | No |
| Material J | 1.0 | 8.9 | 0.4 | 0.3 | | | No |
| SCM420 | 0.2 | 0.2 | 0.3 | 1.4 | | | — |
| SAE4150 | 0.5 | 1.0 | 0.3 | 0.8 | 0.2 | | — |

Each of the retaining pieces was made of Nylon. Each of the retaining pieces had a pair of concave surfaces facing adjacent ones of the balls. Each of the concave surfaces was shaped like a cone. The outer diameter of each of the retaining pieces was set to be 0.8 times as large as the diameter of each ball. Setting was made so that the total gap S1 was larger than zero (S1>0) whereas the gap S2 between the ball at the head and the ball at the tail on the assumption that one retaining piece at the tail was removed was smaller than 0.8 times as large as the outer diameter ds of each retaining piece (S2<0.8×ds).

The screw shaft, the nut, the balls and the retaining pieces produced in the aforementioned manner were assembled into a ball screw according to each of combinations shown in Table 2. The ball screw thus produced was used as a sample to be subjected to the test.

<Test Condition>

Bearing Number: NSK ball screw 25×10×500-C5 (ball diameter: 3/16 inch)
Testing Machine: ball screw durability life tester made by NSK Ltd.
Test Load: axial load 5800 N (P/C=0.5)
Number of Revolutions: 200 r.p.m.
Stroke: 60 mm
Lubricant: mineral oil grease

Results of the test are shown in Table 4.

The life ratio shown in Table 4 is expressed as a ratio in the case where the lifetime obtained in Comparative Example 12 is regarded as a standard (1.0). Incidentally, the reason why Comparative Example 12 is used as a standard is based on the fact that each of the screw shaft and the nut is made of SCM420 which is a steel material heretofore generally used.

TABLE 4

| | | | Life | Retaining |
|---|---|---|---|---|
| | Screw shaft | Nut | ratio | Pieces |
| Example 8 | Material A | Material A | 3.9 | present |
| Example 9 | Material B | Material B | 5.1 | |
| Example 10 | Material C | Material C | 6.2 | |
| Example 11 | Material D | Material D | 7.0 | |
| Example 12 | Material E | Material E | 6.8 | |
| Example 13 | Material F | Material F | 6.4 | |
| Example 14 | Material G | Material G | 7.8 | |
| Example 15 | Material B | SCM420 | 4.3 | |
| Example 16 | Material D | SCM420 | 6.0 | |
| Comparative | SCM420 | SCM420 | 1.0 | |
| Example 12 | | | | |
| Comparative | SAE4150 | SAE4150 | 0.8 | |
| Example 13 | | | | |
| Comparative | Material H | Material H | 1.3 | |
| Example 14 | | | | |
| Comparative | Material I | Material I | 2.9 | |
| Example 15 | | | | |
| Comparative | Material J | Material J | 2.5 | |
| Example 16 | | | | |
| Comparative | Material C | Material C | 0.6 | Absent |
| Example 17 | | | | |

In each of the ball screw samples of Examples 8 to 16 in which a steel material containing alloy components provided by the second embodiment of the invention is used as any one of the screw shaft and the nut, it is obvious that the life of the ball screw is improved greatly.

Particularly in each of Examples 13 and 14, this effect is remarkable because the steel material contains Mo or V.

In each of the ball screw samples of Examples 15 and 16, a steel material containing alloy components provided by the invention is used only as the screw shaft. Because the test condition that rolling fatigue occurs easily particularly in the screw shaft is used in the life test, the life improving effect is obtained in each of Examples 15 and 16.

This result means that the life improving effect is obtained when a steel material containing alloy components provided by the second embodiment of the invention is used as the material of at least one member in which rolling fatigue occurs most easily and which is selected from the screw shaft, the nut and the balls in accordance with the condition of use of the ball screw.

On the other hand, in each of Comparative Examples 12, 13 and 14 using steel heretofore generally used, the effect of suppressing the abnormal structure is small because the Cr content is small. As a result, the life is shortened.

In each of Comparative Examples 15 and 16, the Cr content is the range provided by the invention but the Cr content and the C content do not satisfy the relation: C content (% by weight)≦−0.05×Cr content (% by weight)+1.41 (% by weight). For this reason, large-size eutectic carbide is produced in the steel, so that local stress concentration occurs to promote rolling fatigue. As a result, the life is shortened.

In Comparative Example 17, the screw shaft and the nut each using a steel material containing alloy components provided by the second embodiment of the invention are used in combination but there is no retaining piece. For this reason, the competition between adjacent ones of the balls occurs so that frictional damage of ball surfaces is severe. The lubricating state is worsened remarkably due to reduction in surface roughness of each ball and penetration of abraded steel powder into grease, so that surface fatigue occurs early. As a result, the life is shortest.

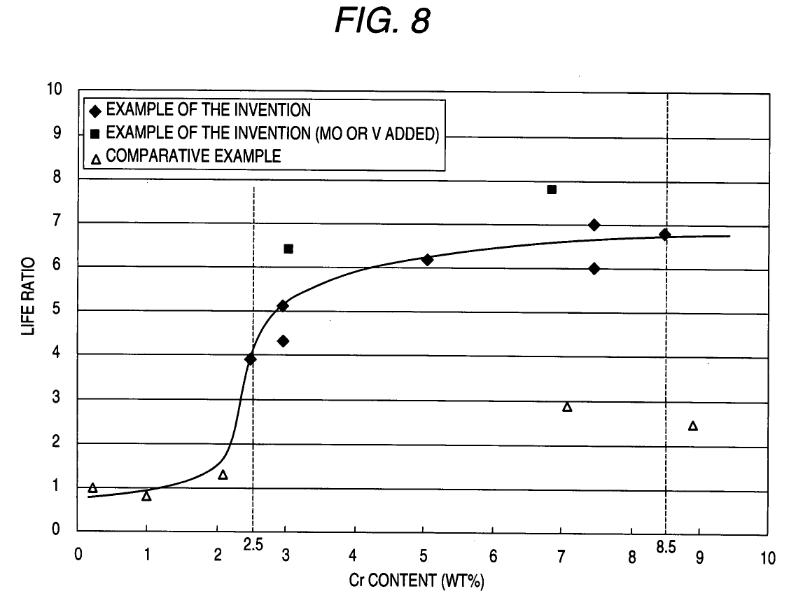

As shown in FIG. 8, the test results are expressed in the relation between the Cr content and the lifetime. It is obvious that the life of the ball screw is improved remarkably when a steel material containing 2.5% by weight to 8.5% by weight, both inclusively, of Cr is used in the ball screw. Particularly when the steel material contains Mo or V, the life of the ball screw is improved remarkably. Accordingly, the validity of the invention is proved.

As described above, according to the second embodiment of the invention, because the retaining pieces each having a pair of concave surfaces facing adjacent ones of the rolling elements respectively are disposed between adjacent ones of the rolling elements, the rolling elements roll and circulate together with the retaining pieces in the rolling element groove, for example, while being in very-low frictional contact with the concave surfaces of the retaining pieces. As a result, the competition between the rolling elements can be prevented, so that operation failure, production of noise or abnormal sound and frictional damage of the rolling elements can be prevented from being caused by the competition between the rolling elements.

Furthermore, a considerably large number of load rolling elements can be disposed compared with the linear motion device using spacer balls, so that elongation in life can be attained without reduction in allowable load capacity.

Furthermore, because at least one kind of the shaft, the linear motion body and the rolling elements is made of steel containing 0.4% by weight to 0.9% by weight, both inclusively, of C, 2.5% by weight to 8.5% by weight, both inclusively, of Cr, 0.1% by weight to 2.0% by weight, both inclusively, of Si, 0.1% by weight to 2.0% by weight, both inclusively, of Mn, and the residual part of Fe or inevitable impurities while satisfying the relation: C content (% by weight)≦−0.05×Cr content (% by weight)+1.41 (% by weight), the metal structure can be stabilized so that the generation of an abnormal structure can be restrained from being caused by rolling fatigue of the inside of the material just under the contact ellipse on which a large amount of shearing force acts. Accordingly, inside start type peeling can be prevented.

Preferably, in the above linear motion device, because the steel having the components as described above further contains at least one component selected from the group consisting of 0.1% by weight to 1.5% by weight, both inclusively, of Mo, and 0.1% by weight to 1.5% by weight, both inclusively, of V, increase of the size of coarse crystal particles at the time of heat treatment is prevented as well as fine carbide is formed. As result, the metal structure can be stabilized so that the generation of the abnormal structure can be suppressed greatly. Accordingly, inside start type peeling can be prevented from being caused by rolling fatigue of the portion on which a high load acts, so that the life of the ball screw can be elongated.

Next, a description will be given of a third embodiment of the invention.

As shown in FIG. 9, the screw shaft 3 is provided for guiding the nut 7 along the axial direction of the screw shaft 3 and has the male thread groove 3a which is helically formed over the whole length of the outer circumferential surface so as to be shaped like a so-called Gothic arch in which circular arcs having a curvature radius Rg not smaller than 52.5% and not larger than 55% of the diameter D of each ball 9 cross each other at an intermediate portion.

The screw shaft 3 is made of carburized bearing steel such as SCM420 or induction hardened steel such as SAE4150, which is heated so that the surface hardness of the material is adjusted to about HRC 56-63. The pitch of the male thread groove 3a can be selected at option according to the specification of an apparatus (not shown) in which the ball screw 1 will be incorporated.

The nut 7 is provided to move linearly along the axial direction of the screw shaft 3 and is cylindrically shaped. A flange 11 for fixing the nut 7 to a table (not shown) or the like of the apparatus is formed at one end of the nut 7. A portion of an outer circumferential surface of the nut 7 is cut away, so that a flat portion 13 is formed in the cut portion.

The nut 7 is made of carburized bearing steel such as SCM420 or induction hardened steel such as SAE4150, which is heated and hardened so that the surface hardness of the material is adjusted to about HRC 56-63.

The female thread groove 5 the same in shape and pitch as the male thread groove 3a is formed in the inner circumferential surface of the nut 7. That is, the female thread groove 5 is shaped like a so-called Gothic arch in which circular arcs having a curvature radius Rg not smaller than 52.5% and not larger than 55% of the diameter D of each ball 9 cross each other at an intermediate portion.

Each of the balls 9 is made of high-carbon chromium bearing steel such as SUJ2, which is quench-hardened to have a surface hardness of not lower than HRC 60.

The remaining components and operations of the ball screw of the third embodiment are identical to those of the first embodiment.

In the third embodiment, the inventors have made examination for many years about fatigue damage produced in the use condition of high rotational speed and high load in spite of interposition of the retaining pieces 21 between the rolling balls 9 to eliminate the competition between the balls 9. As a result, it has been found that inside start type peeling is a damage mode other than surface start type peeling heretofore regarded as being caused by lubricating failure.

That is, there has been obtained the knowledge that a large amount of shearing force acts on the inside of the material just under the contact ellipse so that an abnormal structure produced with the advance of rolling fatigue of the inside of the material becomes a factor of peeling.

The abnormal structure is a structure called “white structure” in which dispersion of carbon contained in cementite in the metal structure is caused by rolling fatigue. Although the mechanism of generation of such an abnormal structure is not clear for the time being, it is conceivable that the abnormal structure will be caused by a mechanochemical reaction or hydrogen penetrating into steel because the abnormal structure is apt to be generated under the condition of large slip due to the change of the loaded state, large differential slip and spin-slip at the contact ellipse and high load.

As shown in FIG. 9, in the ball screw 1 according to this embodiment, the curvature radius Rg of at least one of the male thread groove 3a and the female thread groove 5 is selected to be not smaller than 52.5% and not larger than 55% as large as the diameter D of each ball 9. Accordingly, because the curvature radius Rg is larger than the curvature radius used in the related art, the area of the contact ellipse is reduced so that slip at the contact point is reduced. As a result, the generation of an abnormal structure is suppressed so that the life of the ball screw 1 can be elongated.

If the curvature radius Rg of the thread groove is smaller than 52.5%, the effect of reducing slip is so low that the effect of suppressing the abnormal structure is low. If the curvature radius Rg of the thread groove is larger than 55%, the area of the contact ellipse is so small that the surface pressure increases to shorten the life of the ball screw 1. In addition, the stiffness of the ball screw 1 is reduced to bring bad influence on positioning accuracy.

In consideration of the abnormal structure-suppressing effect and the surface pressure of the contact ellipse, the curvature radius Rg of the thread groove is selected to be preferably in a range of from 52.5% to 55%, both inclusively, especially in a range of from 53% to 54%, both inclusively, as large as the diameter D of each ball 9.

### Examples of the Third Embodiment

Examples concerning the ball screw according to the third embodiment of the invention and Comparative Examples for making comparison with the Examples will be described. That is, a test executed on Examples 17 to 24 for confirming the effect of the ball screw according to the invention and executed on Comparative Examples 18 to 22 for making comparison with the Examples 17 to 24 will be described.

A ball screw known by the bearing number “25×10×500-C5” according to JIS-1192 was used in the test. The ball screw was mounted into in a ball screw durability life tester made by NSK Ltd. in the following condition. Whenever a predetermined time passed, the test was interrupted to check whether the screw shaft was peeled or not. The time until peeling is generated was regarded as the lifetime.

Each of the screw shaft and the nut was made of carburized bearing steel SCM420 which was carburized and quench-hardened. Each of the male thread groove and the female thread groove was produced so as to be shaped like a Gothic arch having a curvature radius expressed in W with respect to the diameter D of each ball in Table 1.

A steel-ball made of SUJ2 having a diameter of 4.76 mm ( 3/16 inches) was used as each of the balls.

Incidentally, in each of Examples 17 to 22, both the screw shaft and the nut had thread grooves each having a curvature radius selected to be in the range provided by this embodiment.

In each of Examples 7 and 8, the male thread groove of the screw shaft had a curvature radius selected to be in the range provided by this embodiment but the female thread groove of the nut has a curvature radius smaller than the range provided by this embodiment.

TABLE 5

Thread groove
curvature radius/
ball diameter (%)

| | Screw shaft | Nut | Life ratio |
|---|---|---|---|
| Example 17 | 52.5 | 52.5 | 2.0 |
| Example 18 | 53.0 | 53.0 | 2.7 |
| Example 19 | 53.5 | 53.5 | 2.8 |
| Example 20 | 54.0 | 54.0 | 2.8 |
| Example 21 | 54.5 | 54.5 | 2.1 |
| Example 22 | 55.0 | 55.0 | 1.7 |
| Example 23 | 53.0 | 52.0 | 2.5 |
| Example 24 | 54.0 | 52.0 | 2.4 |
| Comparative | 51.5 | 51.5 | 0.8 |
| Example 18 | | | |
| Comparative | 52.0 | 52.0 | 1.0 |
| Example 19 | | | |
| Comparative | 55.5 | 55.5 | 0.8 |
| Example 20 | | | |
| Comparative | 56.0 | 56.0 | 0.7 |
| Example 21 | | | |
| Comparative | 53.0 | 53.0 | 0.4 |
| Example 22 | | | |

Each of the retaining pieces used was made of Nylon. Each of the retaining pieces had a pair of concave surfaces facing adjacent ones of the balls. Each of the concave surfaces was shaped like a cone. The outer diameter of each of the retaining pieces was set to be 0.8 times as large as the diameter of each ball. Setting was made so that the total gap S1 was larger than zero (S1>0) whereas the gap S2 between the ball at the head and the ball at the tail on the assumption that one retaining piece at the tail was removed was smaller than 0.8 times as large as the outer diameter ds of each retaining piece (S2<0.8×ds).

In Comparative Example 22, a full ball screw structure was used so that the balls were disposed densely without use of any retaining piece in order to confirm the effect of the retaining pieces.

Grease obtained by adding an extreme pressure agent and an antirust agent added to a mineral-based grease for facilitating production of a mechanochemical reaction was used as lubricating grease.

<Test Condition>

Bearing Number: NSK ball screw 25×10×500-C5 (ball diameter: 3/16 inch)
Testing Machine: ball screw durability life tester made by NSK Ltd.
Test Load: axial load 5800 N (P/C=0.5)
Number of Revolutions: 500 r.p.m.
Stroke: 40 mm
Lubricant: mineral oil grease

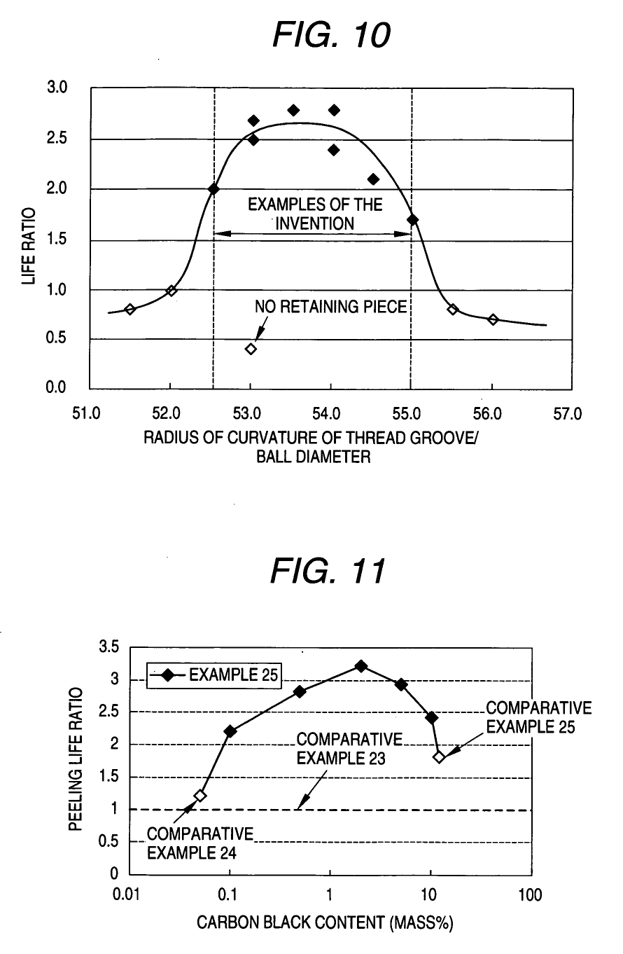

Results of the test were shown in Table 5 and also in FIG. 10 which shows the correlation between the ratio of the curvature radius of the male thread groove of the screw shaft to the diameter of each ball and the life ratio. Incidentally, the life ratio shown in Table 5 and FIG. 10 is expressed as a ratio in the case where the lifetime obtained in Comparative Example 19 is regarded as a standard (1.0).

In each of the ball screw samples of Examples 17 to 22, the curvature radius of the thread groove of each of the screw shaft and the nut is in the range provided by this embodiment. Because slip becomes slight at contact points between each ball and the male thread groove and between each ball and the female thread groove, the generation of the abnormal structure is suppressed. Even in Example 22 exhibiting the minimum value, the life ratio reaches 1.7. In each of Examples 19 and 20 exhibiting the maximum value, the life ratio reaches 2.8. It is obvious that the life ratio is improved greatly.

In each of Examples 23 and 24, the curvature radius of the male thread groove of the screw shaft is in the range provided by this embodiment but the curvature radius of the female thread groove of the nut is smaller than the range provided by this embodiment.

Although the test condition that fatigue damage of the screw shaft occurs easily is used in the life test carried out in this time, slip at the contact point of the thread groove having a curvature radius in the range provided by this embodiment is so small that the generation of the abnormal structure is suppressed to improve the life.

This result suggests that improvement in the life can be expected when the ball screw is produced so that the curvature radius of the thread groove of any one of the screw shaft and the nut having the highest possibility of rolling fatigue is selected to be in the range provided by this embodiment according to the condition of use of the ball screw.

On the other hand, in each of Comparative Examples 18 and 19, the curvature radius of the thread groove of each of the screw shaft and the nut is selected to be smaller than the range provided by this embodiment. For this reason, slip at contact points between each ball and the male thread groove and between each ball and the female thread groove becomes so large that the abnormal structure is generated easily. As a result, peeling occurs and results in shortening the life.

In each of Comparative Examples 20 and 21, the curvature radius of the thread groove of each of the screw shaft and the nut is selected to be larger than the range provided by this embodiment. For this reason, slip at contact points between each ball and the male thread groove and between each ball and the female thread groove is small but the area of the contact ellipse is reduced so that the surface pressure increases. As a result, rolling fatigue occurs easily and results in shortening the life.

In Comparative Example 22, the curvature radius of the thread groove of each of the screw shaft and the nut is in the range provided by this embodiment but no retaining piece is used. For this reason, the competition between adjacent ones of the balls occurs so that the surfaces of the balls are abraded and damaged remarkably. The life in Comparative Example 22 is the shortest.

FIG. 10 shows the results of the test as the correlation between the ratio of the curvature radius of the thread groove of the screw shaft to the diameter of each ball and the life ratio.

It is obvious that the life of the ball screw is improved greatly when the curvature radius of the thread groove is in a range of 52.5% to 55% as large as the diameter D of each ball. Particularly when the curvature radius is in a range of from 53% to 54%, the improvement is remarkable.

It is to be understood from the results of the test that the life of the ball screw can be improved when the curvature radius of the thread groove of at least one of the screw shaft and the nut is optimized to be in the range provided by this embodiment.

As described above, in the ball screw according to the third embodiment of the invention, retaining pieces each having a pair of concave surfaces facing adjacent ones of the balls respectively are disposed between the adjacent ones of the balls.

Accordingly, the balls circulate and roll together with the retaining pieces in the rolling path while being in very low-frictional contact with the concave surfaces (e.g., each shaped like a Gothic arch) of the retaining pieces. The competition between the balls can be prevented, so that operation failure, production of noise or abnormal sound and frictional damage of the balls can be prevented from being caused by the competition between the balls.

Furthermore, a considerably large number of load balls can be disposed compared with the ball screw using spacer balls. Elongation of the life can be attained without reduction in allowable load capacity.

Furthermore, because the curvature radius of the section along the axial line of at least one of the male thread groove and the female thread groove is selected to be in a range of from 52.5% to 55%, both inclusively, as large as the diameter of each ball, the generation of the abnormal structure due to rolling fatigue can be suppressed so that peeling can be prevented from being caused by the abnormal structure.

Moreover, because the thread groove is shaped like a Gothic arch in sectional view, the gap between the edge of the thread groove and each ball can be prevented from becoming excessive even in the case where the curvature radius of the thread groove is set to be larger than ordinary in order to reduce the area of the contact ellipse to reduce slip at the contact point. Accordingly, accuracy in positioning the screw shaft and the nut can be kept good.

Next, a description will be given of a fourth embodiment of the invention. The fourth embodiment is characterized by a grease composition to be enclosed in a ball screw, and the basic structure and operation of the ball screw are identical to those of the first embodiment.

Incidentally, in the fourth embodiment, materials of respective members constituting the ball screw 1 are not limited. Known materials can be used as the materials of respective members. For example, SCM420 carburized and quench-hardened may be used as the material of each of the screw shaft 3 and the nut 7. High-carbon chromium bearing steel such as SUJ2 or high-carbon chromium bearing steel subjected to a hardening process such as carbonitriding may be used as the material of the balls 9.

A grease composition is enclosed in between the male thread groove 3a and the female thread groove 5 in the ball screw 1. The grease composition is enclosed by a seal 19, which is provided on each of both ends of the nut 7. The amount of enclosed grease is not particularly limited. The amount of grease generally allowed to be enclosed in this type ball screw may be used. The grease composition will be described below in detail.

<Base Oil>

Base oil used in the grease composition is not particularly limited. All kinds of base oil allowed to be used for a lubricant can be used. To avoid production of abnormal noise in operation under a low-temperature environment and to avoid burning at a high temperature where an oil film cannot be formed sufficiently, base oil having a dynamic viscosity of 50 mm²/s to 600 mm²/s at 40° C. is used preferably. More preferably, base oil having a dynamic viscosity of 70 mm²/s to 500 mm²/s at 40° C. is used. Especially preferably, base oil having a dynamic viscosity of 100 mm²/s to 450 mm²/s at 40° C. is used.

As the kind of the base oil, any one of mineral oil, synthetic lubricating oil and natural lubricating oil can be used. As the mineral oil, refined mineral oil prepared by a suitable combination of refining processes such as reduced-pressure distillation, oil deasphalting, solvent extraction, hydrogenolysis, solvent dewaxing, sulfuric acid cleaning, clay refining, and hydro-refining may be used preferably. The synthetic lubricating oil is not limited but hydrocarbon-based oil, aromatic-based oil, ester-based oil, ether-based oil, etc. may be used as specific examples thereof which will be described below.

Examples of the hydrocarbon-based oil include normal paraffin, isoparaffin, polybutene, polyisobutylene, poly-α-olefin of 1-decene oligomer, 1-decene and ethylene oligomer, etc., and hydrides thereof.

Examples of the aromatic-based oil include: alkyl benzenes such as monoalkyl benzene, and dialkyl benzene; and alkyl naphthalenes such as monoalkyl naphthalene, dialkyl naphthalene, and polyalkyl naphthalene.

Examples of the ester-based oil include: diesters such as dibutyl sebacate, di-2-ethylhexyl sebacate, dioctyl adipate, diisodecyl adipate, ditridecyl adipate, ditridecyl glutarate, and methyl acetylricinoleate; aromatic esters such as trioctyl trimellitate, tridecyl trimellitate, and tetraoctyl pyromellitate; polyol esters such as trimethylolpropane caprylate, trimethylolpropane pelargonate, pentaerythritol-2-ethyl hexanoate, and pentaerythritol pelargonate; and complex esters such as oligoester of polyhydroxy alcohol and dibasic-monobasic mixed aliphatic acid.

Examples of the ether-based oil include: polyglycols such as polyethylene glycol, polypropylene glycol, polyethylene glycol monoether, and polypropylene glycol monoether; and phenyl ethers such as monoalkyl triphenyl ether, alkyl diphenyl ether, dialkyl diphenyl ether, pentaphenyl ether, tetraphenyl ether, monoalkyl tetraphenyl ether, and dialkyl tetraphenyl ether.

Other examples of the synthetic lubricating oil include tricresyl phosphate, silicone oil, and perfluoroalkyl ether.

Examples of the natural lubricating oil include: fats and fatty oils such as beef tallow, lard, soybean oil, rape seed oil, rice bran oil, coconut oil, palm oil, and palm kernel oil; and hydrides thereof.

These kinds of base oil can be used singly or in combination, so that the viscosity of the base oil can be adjusted suitably to be in the preferred range.

<Thickener>

A thickener used in the grease composition is not particularly limited if the thickener has a function of forming a gel structure to retain the base oil in the gel structure. Specific examples of the thickener include: metal soap such as metal soap containing Li, Na or the like, and composite metal soap containing members selected from the group consisting of Li, Na, Ba, and Ca; and nonsoap such as bentonite, silica gel, urea compounds, urea-urethane compounds, and urethane compounds. In consideration of heat resistance of the grease composition, urea compounds, urea-urethane compounds, urethane compounds and mixtures thereof may be used preferably. Specific examples of the urea compounds, the urea-urethane compounds and the urethane compounds include diurea compounds, triurea compounds, tetraurea compounds, polyurea compounds, urea-urethane compounds, diurethane compounds, and mixtures thereof. Especially, diurea compounds, urea-urethane compounds, diurethane compounds and mixtures thereof may be used preferably. More especially, diurea compounds may be mixed preferably.

The concentration of the thickener in the grease composition is not limited if the thickener can cooperate with the oil base to form grease. Preferably, the ratio of the amount of the thickener to the total amount of the grease composition is selected to be in a range of from 3% by mass to 35% by mass.

<Electrically Conductive Substance>

An electrically conductive substance used in the grease composition is not particularly limited if it has no bad influence on lubricating characteristic and is good in electrically conducting characteristic. The electrically conductive substance may be solid or liquid. Especially, carbon black, graphite, carbon nanotube, metal powder, or the like, may be preferably used because it is inexpensive and available. More especially, carbon black or carbon nanotube may be used preferably. Although products available on the market can be used as these substances, substances having a mean particle size of 10 nm to 300 nm are preferably selected because the substances are excellent in donation of electrically conducting characteristic and dispersibility.

The amount of the electrically conductive substance added to the grease composition is selected to be in a range of from 0.1% by mass to 10% by mass, preferably in a range of from 0.5% by mass to 5% by mass with respect to the total amount of the grease composition. If the amount of the electrically conductive substance is smaller than 0.1% by mass, there is a possibility that sufficient electrically conducting characteristic cannot be given to the grease composition. On the other hand, if the amount of the electrically conductive substance is larger than 10% by mass, there is a possibility that the grease composition may be hardened to shorten the burning life of the ball screw.

<Other Additives>

As occasion demands, various kinds of additives as generally added to a grease composition may be added to the grease composition. Examples of the additives include: anti-oxidants such as an amine-based anti-oxidant, a phenol-based anti-oxidant, a sulfur-based anti-oxidant, and a thiophosphozinc-based anti-oxidant; extreme pressure agents such as a chlorine-based agent, a sulfur-based agent, a phosphorus-based agent, a dithiophosphozinc-based agent, and an organic molybdenum-based agent; an antirust such as sorbitan ester; oily substances such as fatty acid, animal oil, and vegetable oil; metal deactivators such as benzotriazole; and viscosity index improvers such as polymethacrylate, polyisobutylene, and polystyrene.

The consistency of the grease composition is preferably in a range of from 1 to 3 in terms of NLGI number.

### Example of the Fourth Embodiment

The invention will be described below more specifically in connection with the following Example and Comparative Examples but the invention is not limited thereto at all.

A screw shaft and a nut for a ball screw (“bearing number: 25×10×500-C5” made by NSK Ltd.) were produced and a grease composition prepared in proportion shown in Table 6 was enclosed therein. In this manner, ball screw samples used in Example 25 and Comparative Examples 23 to 25 were prepared. Carbon black (“KETJENBLACK” made by Lion Corp.; mean particle size: 30 nm) was used as an electrically conductive substance. Incidentally, SCM420 carburized and quench-hardened was used as the material of each of the screw shaft and the nut whereas a steel ball of SUJ2 having a ball diameter of 4.76 mm was used as each of balls. In Example 25 and Comparative Example 24, retaining pieces each made of Nylon and having concave surfaces formed as shown in FIG. 3 were interposed between the balls. In Comparative Examples 23 and 25, the balls were disposed densely without use of any retaining piece.

TABLE 6

| | Example | Comparative | Comparative | Comparative |
|---|---|---|---|---|
| | 25 | Example 23 | Example 24 | Example 25 |
| Thickener | Urea compound | | | |
| Base oil | Poly-α-olefin | | | |
| Base oil dynamic | 200 | | | |
| viscosity (mm²/s, | | | | |
| 40° C.) | | | | |
| Carbon black | 0.1-10 | 0 | 0.05 | 12 |
| content (mass %) | | | | |

A durability life test was carried out on each ball screw sample by a ball screw durability life tester made by NSK Ltd. in the following test condition. Whenever a predetermined time passed, the test was interrupted to check whether the screw shaft was peeled or not. The time until peeling is generated was regarded as the lifetime.
Axial Load: 5800 N (P/C=0.5)
Maximum Rotational Speed: 500 min⁻¹
Stroke: 40 mm

FIG. 11 shows results of the test. In FIG. 11, the peeling life ratio is expressed in a ratio in the condition that the lifetime of the ball screw sample used in Comparative Example 23 is regarded as 1.0. Incidentally, the peeling life ratio in Comparative Example 25 was obtained not on the basis of the lifetime obtained by checking peeling of the screw shaft but on the basis of the time when the test was terminated because of burning. As is obvious from FIG. 11, it is confirmed that the ball screw sample of Example 1 in which the retaining pieces are interposed between the balls and the grease composition containing 0.1% by mass to 10% by mass of the electrically conductive substance is enclosed according to the invention is very long in durability life.

As described above, the ball screw according to the invention can be kept long-lived even in the case where the ball screw is used in an environment that a high load is imposed on the ball screw.

Next, a description will be given of a fifth embodiment of the invention. Like the fourth embodiment, the fifth embodiment is also characterized by a grease composition to be enclosed in the ball screw, and the structure and operation of the ball screw are identical to those of the first embodiment.

Incidentally, in the fifth embodiment, materials of respective members constituting the ball screw 1 are not limited. Known materials can be used as the materials of respective members. For example, SCM420 carburized and quench-hardened may be used as the material of each of the screw shaft 3 and the nut 7. High-carbon chromium bearing steel such as SUJ2 or high-carbon chromium bearing steel subjected to a hardening process such as carbonitriding may be used as the material of the balls 9.

A grease composition is enclosed in between the male thread groove 3a and the female thread groove 5 in the ball screw 1. The grease composition is enclosed by a seal 19, which is provided on each of both ends of the nut 7. The amount of enclosed grease is not particularly limited. The amount of grease generally allowed to be enclosed in this type ball screw may be used. The grease composition will be described below in detail.

<Base Oil>

Base oil used in the grease composition is not particularly limited. All kinds of base oil allowed to be used for a lubricant can be used. To avoid production of abnormal noise in operation under a low-temperature environment and to avoid burning at a high temperature where an oil film cannot be formed sufficiently, base oil having a dynamic viscosity of 50 mm²/s to 600 mm²/s at 40° C. is used preferably. More preferably, base oil having a dynamic viscosity of 70 mm²/s to 500 mm²/s at 40° C. is used. Especially preferably, base oil having a dynamic viscosity of 100 mm²/s to 450 mm²/s at 40° C. is used.

As the kind of the base oil, any one of mineral oil, synthetic lubricating oil and natural lubricating oil can be used. As the mineral oil, refined mineral oil prepared by a suitable combination of refining processes such as reduced-pressure distillation, oil deasphalting, solvent extraction, hydrogenolysis, solvent dewaxing, sulfuric acid cleaning, clay refining, and hydro-refining may be used preferably. The synthetic lubricating oil is not limited but hydrocarbon-based oil, aromatic-based oil, ester-based oil, ether-based oil, etc. may be used as specific examples thereof which will be described below.

Examples of the hydrocarbon-based oil include normal paraffin, isoparaffin, polybutene, polyisobutylene, poly-α-olefin of 1-decene oligomer, 1-decene and ethylene oligomer, etc., and hydrides thereof.

Examples of the aromatic-based oil include: alkyl benzenes such as monoalkyl benzene, and dialkyl benzene; and alkyl naphthalenes such as monoalkyl naphthalene, dialkyl naphthalene, and polyalkyl naphthalene.

Examples of the ester-based oil include: diesters such as dibutyl sebacate, di-2-ethylhexyl sebacate, dioctyl adipate, diisodecyl adipate, ditridecyl adipate, ditridecyl glutarate, and methyl acetylricinoleate; aromatic esters such as trioctyl trimellitate, tridecyl trimellitate, and tetraoctyl pyromellitate; polyol esters such as trimethylolpropane caprylate, trimethylolpropane pelargonate, pentaerythritol-2-ethyl hexanoate, and pentaerythritol pelargonate; and complex esters such as oligoester of polyhydroxy alcohol and dibasic-monobasic mixed aliphatic acid.

Examples of the ether-based oil include: polyglycols such as polyethylene glycol, polypropylene glycol, polyethylene glycol monoether, and polypropylene glycol monoether; and phenyl ethers such as monoalkyl triphenyl ether, alkyl diphenyl ether, dialkyl diphenyl ether, pentaphenyl ether, tetraphenyl ether, monoalkyl tetraphenyl ether, and dialkyl tetraphenyl ether.

Other examples of the synthetic lubricating oil include tricresyl phosphate, silicone oil, and perfluoroalkyl ether.

Examples of the natural lubricating oil include: fats and fatty oils such as beef tallow, lard, soybean oil, rape seed oil, rice bran oil, coconut oil, palm oil, and palm kernel oil; and hydrides thereof.

These kinds of base oil can be used singly or in combination, so that the viscosity of the base oil can be adjusted suitably to be in the preferred range.

<Thickener>

A thickener used in the grease composition is not particularly limited if the thickener has a function of forming a gel structure to retain the base oil in the gel structure. Specifically, metal soap such as metal soap containing Li, Na or the like, and composite metal soap containing members selected from the group consisting of Li, Na, Ba, and Ca; and nonsoap such as bentonite, silica gel, urea compounds, urea-urethane compounds, and urethane compounds, can be selected suitably and used. In consideration of production of a firm oil film and heat resistance of the grease composition, urea compounds, urea-urethane compounds, urethane compounds and mixtures thereof may be used preferably. Specific examples of the urea compounds, the urea-urethane compounds and the urethane compounds include diurea compounds, triurea compounds, tetraurea compounds, polyurea compounds, urea-urethane compounds, diurethane compounds, and mixtures thereof. Especially, diurea compounds, urea-urethane compounds, diurethane compounds and mixtures thereof maybe used preferably. More especially, diurea compounds may be mixed preferably.

To make high-temperature stability better, the thickener is selected from diurea compounds represented by the following general formulae (1) to (3).

[Chemical Formulae 1]

(a) General Formula (1)

(b) General Formula (2)

(c) General Formula (3)

In the formulae, R₁ is an aromatic ring-containing hydrocarbon group having a carbon number of from 7 to 12, R₂ is a bivalent aromatic ring-containing hydrocarbon group having a carbon number of 6 to 15, and R₃ is a cyclohexyl group or an alkylcyclohexyl group having a carbon number of 7 to 12. Especially, the diurea compound is preferably selected so that the ratio of the number of moles of R₁ to the sum of the number of moles of R₁ and the number of moles of R₃ in each of the diurea compounds represented by the general formulae (1) to (3) is in a range of from 0 to 0.55.

The urea compound is preferably mixed so that the ratio of the amount of the urea compound to the total amount of the grease composition is in a range of from 10% by mass to 35% by mass.

<Additives>

Various kinds of additives may be mixed with the grease composition as occasion demands. Incidentally, in the invention, it is necessary to remove sulfonate in order to restrain occurrence of a mechanochemical reaction. Among additives allowed to be used, the following nephthenate and succinic derivatives may be added preferably in order to keep antirust characteristic and improve peeling resistance.

<Naphthenate>

Naphthenate is not particularly limited if it is saturated carboxylate having a naphthene nucleus. Main examples of the naphthenate include saturated monocyclic carboxylate CₙH₂ₙ₋₁COOM, saturated dicyclic carboxylate CₙH₂ₙ₋₃COOM, aliphatic carboxylate CₙH₂ₙ₊₁COOM, and derivatives thereof. Examples of the monocyclic carboxylate can be represented by the following formulae.

[Chemical Formulae 2]

In the formulae, R₄ is a hydrocarbon group such as an alkyl group, an alkenyl group, an aryl group, an alkalyl group or an aralkyl group, and M is a metallic element such as Co, Mn, Zn, Al, Ca, Ba, Li, Mg or Cu. These naphthenates may be used singly or in combination suitably.

<Succinic Derivative>

Specific examples of the succinic derivative include succinic acid, alkyl succinic acid, alkyl succinic half ester, alkenyl succinic acid, alkenyl succinic half ester, and imide succinate. These succinic derivatives may be used singly or in combination suitably.

The naphthenate and succinic derivative may be used singly or in combination. When used singly or in combination, the preferred ratio of the amount of the added naphthenate and/or succinic derivative to the total amount of the grease composition is in a range of from 0.1% by mass to 10% by mass. If the amount of the added naphthenate and/or succinic derivative is smaller than 0.1% by mass, sufficient antirust characteristic cannot be obtained. If the amount of the added naphthenate and/or succinic derivative is larger than 10% by mass, the grease is softened undesirably so that there is a possibility of grease leakage. In consideration of sure antirust characteristic and the burning life due to grease leakage, the ratio of the amount of the naphthenate and/or succinic derivative to the total amount of the grease composition may be preferably selected to be in a range of from 0.25% by mass to 5% by mass.

To improve peeling resistance more greatly, the following organometallic salt may be added preferably.

<Organometallic Salt>

A dialkyl dithiocarbamic acid (DTC)-based compound represented by the following general formula (4) and a dialkyl dithiophosphoric acid (DTP)-based compound represented by the following general formula (5) can be preferably used as the organometallic salt.

<Chemical Formulae 3>

In the formulae, M is a metallic species. Specifically, Sb, Bi, Sn, Ni, Te, Se, Fe, Cu, Mo or Zn can be used as M. R₅ and R₆ may be the same group or may be different groups. Each of R₅ and R₆ is selected from the group consisting of an alkyl group, a cycloalkyl group, an alkenyl group, an aryl group, an alkylaryl group, and an arylalkyl group. Examples of the especially preferable group include 1,1,3,3-tetramethylbutyl group, 1,1,3,3-tetramethylhexyl group, 1,1,3-trimethylhexyl group, 1,3-dimethylbutyl group, 1-methylundecane group, 1-methylhexylgroup, 1-methylpentylgroup, 2-ethylbutylgroup, 2-ethylhexylgroup, 2-methylcyclohexyl group, 3-heptyl group, 4-methylcyclohexyl group, n-butyl group, isobutyl group, isopropyl group, isoheptyl group, isopentyl group, undecyl group, eicosyl group, ethyl group, octadecyl group, octyl group, cyclooctyl group, cyclododecyl group, cyclopentyl group, dimethylcyclohexyl group, decyl group, tetradecyl group, docosyl group, dodecyl group, tridecyl group, trimethylcyclohexyl group, nonyl group, propyl group, hexadecyl group, hexyl group, heneicosyl group, heptadecyl group, heptyl group, pentadecyl group, pentyl group, methyl group, tertiary butylcyclohexyl group, tertiary butyl group, 2-hexenyl group, 2-methallyl group, allyl group, undecenyl group, oleyl group, decenyl group, vinyl group, butenyl group, hexenyl group, heptadecenyl group, tolyl group, ethylphenyl group, isopropylphenyl group, tertiary butylphenyl group, secondary pentylphenyl group, n-hexylphenyl group, tertiary octylphenyl group, isononylphenyl group, n-dodecylphenyl group, phenyl group, benzyl group, 1-phenylmethyl group, 2-phenylethyl group, 3-phenylpropyl group, 1,1-dimethylbenzyl group, 2-phenylisopropyl group, 3-phenylhexyl group, benzhydryl group, and biphenyl group. These groups may contain ether linkage.

As other organometallic salts, organic zinc compounds represented by the following general formulae (6) to (8) may be used.

[Chemical Formulae 4]

In the formulae, each of R₇ and R₈ is either hydrocarbon group having a carbon number (n in Cₙ) of 1 to 18 or hydrogen atom. R₇ and R₈ may be the same group or may be different groups. Especially, methylcaptobenzothiazole zinc (formula (6)), benzamidothiophenol zinc (formula (7)) and mercaptobenzimidazole zinc (formula (8)) in each of which both R₇ and R₈ are hydrogen atoms can be used preferably.

As a further organometallic salt, zinc alkylxanthogenate represented by the following general formula (9) may be used.

[Chemical Formula 5]

In the formula, R₉ is a hydrocarbon group having a carbon number (n in Cₙ) of 1 to 18.

Although organometallic salts represented by the general formulae (4) to (9) can be used singly or in combination of two or more kinds, the combination is not particularly limited. The organometallic salt has an effect and function in forming a reaction film in a fine gap to suppress variation and peeling in the white structure. If the amount of the added organometallic salt is smaller than 0.1% by mass, the effect cannot be fulfilled. On the other hand, it may be conceived that the upper limit of the amount of the added organometallic salt need not be particularly limited. The organometallic salt is however relatively expensive. Furthermore, if the amount of the added organnometallic salt is excessive, the reaction with the bearing member is accelerated extraordinarily to make burning performance more poor than good. Accordingly, the amount of the added organometallic salt is selected to be preferably in a range of from 0.1% by mass to 10% by mass, more preferably in a range of from 0.5% by mass to 10% by mass.

<Other Additives>

As occasion demands, various kinds of additives as generally added to a grease composition may be added to the grease composition. Examples of the additives include: anti-oxidants such as an amine-based anti-oxidant, a phenol-based anti-oxidant, a sulfur-based anti-oxidant, and a thiophosphozinc-based anti-oxidant; extreme pressure agents such as a chlorine-based agent, a sulfur-based agent, a phosphorus-based agent, a dithiophosphozinc-based agent, and an organic molybdenum-based agent; oily substances such as fatty acid, animal oil, and vegetable oil; metal deactivators such as benzotriazole; and viscosity index improvers such as polymethacrylate, polyisobutylene, and polystyrene.

The consistency of the grease composition is preferably in a range of from 1 to 3 in terms of NLGI number.

### Examples of the Fifth Embodiment

The invention will be described below more specifically in connection with the following Examples and Comparative Examples but the invention is not limited thereto at all.

A screw shaft and a nut for a ball screw (bearing number “25×10×500-C5” made by NSK Ltd.) were produced and a grease composition prepared in proportion shown in Table 7 was enclosed therein. In this manner, ball screw samples used in Examples 26 to 28 and Comparative Examples 26 and 27 were prepared. Incidentally, SCM420 carburized and quench-hardened was used as the material of each of the screw shaft and the nut whereas a steel ball of SUJ2 having a ball diameter of 4.76 mm was used as each of balls. Retaining pieces each made of Nylon and having concave surfaces formed as shown in FIG. 3 were used.

TABLE 7

| | | | | Comparative | Comparative |
|---|---|---|---|---|---|
| | Example 26 | Example 27 | Example 28 | Example 26 | Example 27 |
| Thickener | Urea compound | | | | |
| Base oil | Mineral | Mineral | Ether | Mineral | Ether |
| | oil | oil | oil | oil | oil |
| Base oil dynamic | 400 | 400 | 200 | 400 | 200 |
| viscosity | | | | | |
| (mm²/s, 40° C.) | | | | | |
| Barium sulfonate | 0 | 0 | 0 | 2 | 2 |
| (mass %) | | | | | |
| Zinc naphthenate | 0.05-12 | 0 | 0 | 2 | 0 |
| (mass %) | | | | | |
| Succinic half | 0 | 0.05-12 | 0 | 0 | 0 |
| ester (mass %) | | | | | |
| Nickel | 0 | 0 | 0.05-12 | 0 | 2 |
| dithiocarbamate | | | | | |
| (mass %) | | | | | |

| | |
|---|---|
| Blend | NLGL No. 1 |
| consistency | |

A durability life test was carried out on each ball screw sample by a ball screw durability life tester made by NSK Ltd. in the following test condition. Whenever a predetermined time passed, the test was interrupted to check whether the screw shaft was peeled or not. The time until peeling was regarded as the lifetime.
Axial Load: 5800 N (P/C=0.5)
Maximum Rotational Speed: 500 min⁻¹
Stroke: 40 mm

The amount of zinc naphthenate contained in the grease composition enclosed in the ball screw sample of Example 26 was changed in a range of from 0.05% by mass to 12% by mass. The amount of succinic half ester contained in the grease composition enclosed in the ball screw sample of Example 27 was changed in a range of from 0.05% by mass to 12% by mass. The amount of nickel dithocarbamate contained in the grease composition enclosed in the ball screw sample of Example 28 was changed in a range of from 0.05 W by mass to 12% by mass.

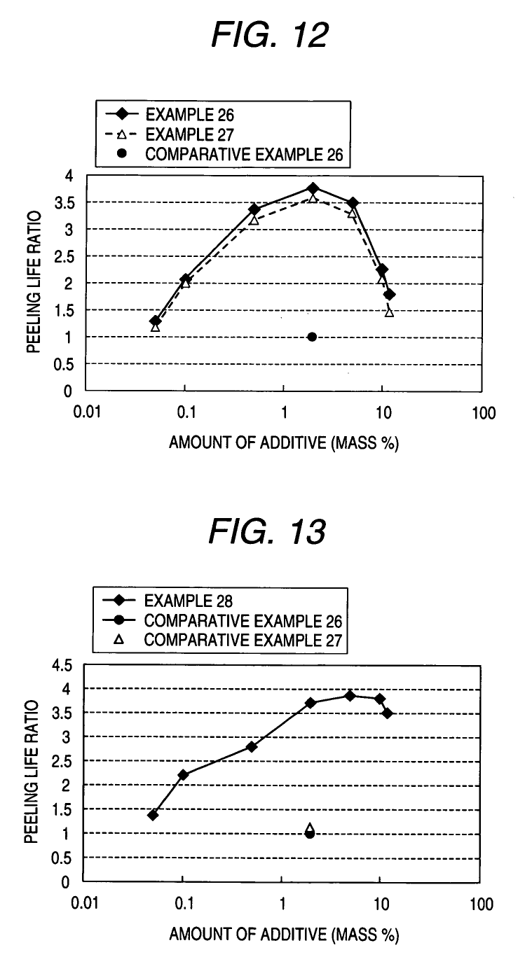

FIG. 12 shows measured results of the peeling life obtained by the ball screw samples of Examples 26 and 27 in terms of the peeling life ratio in the condition that the lifetime of the ball screw sample used in Comparative Example 26 is regarded as 1. It is obvious from FIG. 12 that the peeling life of the ball screw is improved greatly when the grease composition containing 0.1% by mass to 10% by mass of zinc naphthenate or succinic half ester is enclosed in the ball screw.

FIG. 13 shows measured results of the peeling life obtained by the ball screw sample of Example 28 in terms of the peeling life ratio in the condition that the lifetime of the ball screw samples used in Comparative Examples 26 and 27 is regarded as 1. It is obvious from FIG. 13 that the peeling life of the ball screw is improved greatly when the grease composition containing 0.1% by mass to 10% by mass of nickel dithocarbamate is enclosed in the ball screw.

As described above, the ball screw according to the invention can be kept long-lived even in the case where the ball screw is used in an environment that a high load is imposed on the ball screw.

While only certain embodiments of the invention have been specifically described herein, it will apparent that numerous modifications may be made thereto without departing from the spirit and scope of the invention.

1-2. (canceled)

3. A linear motion device comprising:
a shaft;
a linear motion body fitted to said shaft and guided by said shaft so as to be linearly movable in an axial direction of said shaft;
a plurality of rolling elements disposed between said shaft and a rolling element groove formed in an inner circumferential surface of said linear motion body so as to roll freely;
a circulation path formed in said linear motion body, for circulating said rolling elements from one end side of said rolling element groove to the other end side thereof; and
retaining pieces each disposed between adjacent ones of said rolling elements and having two concave surfaces facing said adjacent ones of said rolling elements respectively
wherein at least one kind of said shaft, said linear motion body and said rolling elements is made of steel containing 0.4% by weight to 0.9% by weight, both inclusively, of carbon (C), 2.5% by weight to 8.5% by weight, both inclusively, of chromium (Cr), 0.1% by weight to 2.0% by weight, both inclusively, of silicon (Si), 0.1% by weight to 2.0% by weight, both inclusively, of manganese (Mn), and a residual part of iron (Fe) or inevitable impurities while satisfying a relation: C content (wt %)≦−0.05×Cr content (wt %)+1.41 (wt %).

4. The linear motion device according to claim 3, wherein said at least one kind of said shaft, said linear motion body and said rolling elements contains at least one component selected from the group consisting of 0.1% by weight to 1.5% by weight, both inclusively, of molybdenum (Mo), and 0.1% by weight to 1.5% by weight, both inclusively, of vanadium (V).

5. A ball screw comprising:
a screw shaft having a helical male thread groove formed in its outer circumferential surface;
a nut having a helical female thread groove formed in its inner circumferential surface;
balls interposed in a rolling path formed between said male thread groove and said female thread groove so as to roll freely; and
retaining pieces each disposed between adjacent ones of said balls and having a pair of concave surfaces facing said adjacent ones of said balls,
wherein a section taken along an axial line, of at least one of said male thread groove and said female thread groove has a curvature radius not smaller than 52.5% and not larger than 55% as large as a diameter of each of said balls.

6. The ball screw according to claim 5, wherein said section of each of said male thread groove and said female thread groove is shaped like a Gothic arch.

7. A ball screw comprising:
a screw shaft having a helical male thread groove formed in its outer circumferential surface;
a nut having a helical female thread groove formed in its inner circumferential surface so that said female thread groove is opposed to said male thread groove;
balls interposed between said male thread groove and said female thread groove so as to roll freely; and
retaining pieces each disposed between adjacent ones of said balls and having a pair of concave surfaces facing said adjacent ones of said balls,
wherein a grease composition containing 0.1% by mass to 10% by mass of an electrically conductive substance is enclosed.

8. A ball screw comprising:
a screw shaft having a helical male thread groove formed in its outer circumferential surface;
a nut fit on said screw shaft and having a helical female thread groove formed in its inner circumferential surface to oppose said female thread groove to said male thread groove;
balls interposed between said male thread groove and said female thread groove so as to roll freely; and
retaining pieces each disposed between adjacent ones of said balls and having a pair of concave surfaces facing said adjacent ones of said balls,
wherein a sulfonate-free grease composition is enclosed.

9. The ball screw according to claim 8, wherein said grease composition contains a urea compound as a thickener, and 0.1% by mass to 10% by mass of at least one kind of antirust additive selected from the group consisting of naphthenates, and succinic derivatives.

10. The ball screw according to claim 8, wherein said grease composition contains a urea compound as a thickener, and 0.1% by mass to 10% by mass of organometallic salt.
